(19) United States
(12) Patent Application Publication
(10) Pub. No.: US 2026/0209462 A1
(43) Pub. Date: Jul. 23, 2026

(54) A METHOD OF EXTRACTING THERMOSET RESIN FRACTIONS FOR DECOMPOSITION AND REUSE

(71) Applicants: TEKNOLOGISK INSTITUT, Taastrup (DK); VESTAS WIND SYSTEMS A/S, Aarhus N (DK); OLIN GERMANY UPSTREAM GMBH & CO. KG, Stade (DE)

(72) Inventors: Andreas SOMMERFELDT, Taastrup (DK); Emil DAMGAARD-MØLLER, Taastrup (DK); Simon FRØLICH, Taastrup (DK); Mie REHMEIER, Aarhus N (DK); Markus SCHROETZ, Stade (DE); Konrad GEISSLER, Stade (DE)

(73) Assignees: TEKNOLOGISK INSTITUT, Taastrup (DK); VESTAS WIND SYSTEMS A/S, Aarhus N (DK); OLIN GERMANY UPSTREAM GMBH & CO. KG, Stade (DE)

(21) Appl. No.: 19/138,391

(22) PCT Filed: Dec. 13, 2023
(86) PCT No.: PCT/DK2023/050302

§ 371 Date: Jun. 12, 2025

(30) Foreign Application Priority Data
Dec. 13, 2022 (DK) 2022 70607

(51) Int. Cl. C08J 11/08; C08J 11/28; C09J 5/06; C09J 163/00

(52) U.S. Cl. CPC C08J 11/08; C08J 11/28; C09J 5/06; C09J 163/00; C08J 2363/00; C09J 2463/00

(57) ABSTRACT

A method of extracting of thermoset epoxy fractions from a composite structure comprising thermoset epoxy matrix having a network structure and embedded solid element(s) is described. The method comprises providing a swelling fluid and soaking the composite structure with the swelling fluid including allowing the thermoset epoxy matrix to swell the swelling fluid into the network structure of the thermoset epoxy matrix for a sufficient time to mechanically break up the network structure to form a multitude of thermoset epoxy fractions liberated from the solid elements. Separating at least a portion of the thermoset epoxy fractions from the solid elements to obtain a swelling fluid slurry comprising the portion of the thermoset epoxy fractions in the swelling fluid. The swelling fluid comprises at least 1 mol/L of formic acid.

### TECHNICAL FIELD

The invention relates to a method for extracting of thermoset resin fractions from composite materials for decomposing and reuse.

### BACKGROUND ART

The use of thermosetting cured polymer material especially in the form of complex composite material structures are generally increasing. Especially the use of epoxy materials in the production of bulgy panels or for example wind turbine blades comprises a complex composition of element embedded in epoxy resin, such as metallic layers and/or fibrous layers, e.g. glass fiber layers.

Many attempts of reusing such thermoset resin materials have been provided.

U.S. Pat. No. 10,968,329 describes a method of recovering a decomposition product of a thermosetting resin cured product, the method includes a step of contacting an object to be treated, that contains a thermosetting resin cured product, with a treatment liquid containing an alkali metal compound and an alcohol solvent, to decompose and dissolve the thermosetting resin cured product; a step of mixing the treatment liquid, in which a decomposition product of the thermosetting resin cured product is dissolved, and an acidic aqueous solution to separate the mixture into an aqueous layer and an organic layer containing the decomposition product; and a step of recovering the organic layer.

WO2017/175100 discloses a process for separating reinforcement material from polymer matrix composite comprising the reinforcement material within a thermoset polymer matrix. The process comprises bringing (i) the polymer matrix composite into contact with a reclaim composition comprising a phenolic compound and an acidic or basic catalyst. Through contact with the reclaim composition the thermoset polymer matrix degrades via chain scission and becomes solubilised within the reclaim composition, and consequently releases the reinforcement material into the reclaim composition.

CN113603929 describes a recycling method of an epoxy resin composite material, obtained glass fibers and application of the glass fibers, and relates to the field of organic solid material recycling. The preparation method specifically comprises the following steps: S1, mixing an epoxy resin composite material and a composite solvent, placing the mixture in a pressure container, and controlling the reaction temperature to be 120-150 degrees Celsius and the reaction time to be 3-7 hours to prepare a solid-liquid mixture; and S2, filtering the solid-liquid mixture to obtain a decomposition filtrate and a solid-phase product, wherein the solid-phase product is glass fibers, and the glass fibers are applied to the fields of waterproof base materials, energy-saving auxiliary reinforcing materials, reinforced cementing materials, building decoration materials and the like. The composite solvent is used for degrading the epoxy resin composite material, the experimental process is simple, the reaction condition is mild, the performance of the obtained product is excellent, and the composite solvent is environmentally friendly and has economic benefits.

Generally, these prior art methods are suitable for small element of epoxy or prepreg elements. However, the methods require large reactors for heating or pressing and/or require that the epoxy products are relatively small or require cutting or grinding the epoxy. These methods are therefore not desirable or suitable for use in connection with recycling of thermoset polymer materials such as epoxy resins from large panels or for example wind turbine blades comprises a complex composition of element embedded in cured epoxy resin.

New epoxy resin compositions which are simpler to dissemble have been suggested e.g. as described in WO18050189, however it is still not documented that such new epoxy resin may be fully comparable in mechanical properties and/or cost with customary epoxy resins.

There is therefore still a need for new and effective methods extracting of thermoset resin fractions from large composite structures.

### DISCLOSURE OF INVENTION

An objective of the present invention is to provide a relatively fast and cost effective method of extracting of thermoset polymer fractions from large composite structures, such as wind turbine blades or other relatively large structures comprising a complex composition of element embedded in epoxy material, such as metallic layers, fibrous layers and/or other elements.

In an embodiment, it is an object to provide a method of extracting of thermoset epoxy fractions from relatively large composite structures comprising a thermoset epoxy matrix, such as wind turbine blades, wherein the extracted thermoset epoxy fractions are in the form of granulates suitable for chemical decomposing and optionally reuse in the production of fresh epoxy resin.

In an embodiment, it is an object to provide a method of extracting of thermoset epoxy fractions from large composite structures, which method is economically beneficial and effective and which may be performed relatively fast even where the composite structure is very large.

These and other objects have been solved by the invention or embodiments thereof as defined in the claims and/or as described herein below.

It has been found that the invention or embodiments thereof have a number of additional advantages, which will be clear to the skilled person from the following description.

The inventors of the present invention have found that a surprisingly effective method of breaking down epoxy from even large and complex composite structures to relatively small fractions of epoxy may be provided by using a swelling fluid comprising formic acid as defined in the claims. Beyond being extremely effectively, the method requires very low manpower and is thereby very economically attractive. In addition, it has been found that the swelling fluid may be reused in the method thereby also result in very low cost for the swelling fluid.

Since even very large composite structure may be applied without cutting into smaller pieces, the method is highly attractive for extracting of thermoset resin fractions from construction elements of or comprising composite materials as it will be further described below.

The phrase “composite structure” means herein any structure comprising a thermoset epoxy matrix and at least one embedded solid element, which is not of thermoset epoxy. Normally there will be several embedded solid elements e.g. arranged in layers. Examples of embedded solid elements includes reinforcement elements, such as fibers and/or metallic elements, polymer elements, filler elements, glue, fasteners etc. The composite structure may further comprise non- or partly embedded solid elements or parts thereof, such as coatings e.g. paint and/or UV/weather protective coating.

The term “embedded” should herein be taken to mean that the embedded element is at least partly embedded in the matrix, preferably such that at least 50 volume % of the element is below a surface of the matrix. Advantageously, the embedded element is fully embedded in the matrix, i.e. the embedded element is surrounded by the matrix.

The term “solid element” should herein be taken to mean any solid element that prior to or at the swelling condition is at least partly embedded in the epoxy matrix.

The solid element or elements thereby include all element except for the thermoset epoxy matrix and fractions thereof.

The term “network structure” should herein be taken to mean the cross-linked structure of the thermoset epoxy matrix, which is established upon curing of epoxy resin to form the thermoset epoxy matrix.

The term “thermoset epoxy matrix” should herein be taken to mean a matrix comprising a cured epoxy resin also called polyepoxides. The curing is usually performed by mixing with a hardener.

The terms “hardener” and “curing agent” are used interchangeable to mean a component responsible for reacting with the epoxy groups of an epoxy resin to result in a thermoset epoxy matrix.

The term “soaking” should herein be taken to mean that the composite structure is wetted thoroughly preferably such that the major area of the surfaces of the composite structure is wetted. Advantageously, the phrase soaking of the composite structure means that the composite structure is completely wetted with the swelling fluid.

The term “sprinkling” should herein be taken to mean that the composite structure is soaked by sprinkling to thoroughly wet the major area of the surfaces of the composite structure. The sprinkling may be continuous or discontinuous with periods of sprinkling and periods of non-sprinkling, advantageously such that periods of non-sprinkling is sufficiently short for the wetted surfaces of the composite structure to dry. Preferably periods of non-sprinkling is less than 10 minutes, such as less than 5 minutes, such as less than 1 minute. Advantageously periods of sprinkling are longer than periods of non-sprinkling.

The term “sprinkling” includes splashing and spraying.

The terms “washing” and “washing process” should herein be taken to mean washing the previously embedded solid elements using a washing fluid to obtain a washing fluid slurry comprising at least a portion of the thermoset resin fractions in the washing fluid.

Where the washing is performed using a flush of fluid (flushing fluid”), the washing and the washing process are referred to as respectively “flushing” and “flushing process”.

The term “swelling fluid” should herein be taken to mean a fluid comprising formic acid and being capable of swelling thermoset epoxy matrix. The swelling fluid is advantageously at least partly liquid at the swelling conditions. The swelling fluid may conveniently be a mixture of gas and liquid at the swelling condition. In an embodiment, the swelling fluid is liquid at the swelling condition.

The term “washing fluid” should herein be taken to mean a liquid containing fluid at the washing condition (temperature and pressure), preferably comprising or consisting of water. The washing fluid conveniently comprise surfactant(s) e.g. provided in the form of detergents, preferably low-foaming detergents.

The term “flushing fluid” should herein be taken to mean a sag, a liquid or a mixture thereof at the flushing condition (temperature and pressure). The flushing fluid may conveniently comprise water or steam or pressurized air.

The term “thermoset epoxy fractions” should herein be taken to mean fractions of the thermoset epoxy matrix free of the embedded or previously embedded solid elements. The thermoset epoxy fractions are advantageously relatively small fractions having irregularly surfaces.

The term “rigid” should herein be taken to mean that the rigid body is stiff during the ordinary and intended use of the rigid body in question.

The term “epoxy resin” should herein be taken to mean polyepoxides comprising reactive prepolymers and/or polymers which contain epoxide groups.

The phrases “cured epoxy matrix” and “thermoset epoxy matrix” are used interchangeable and should herein be taken to comprise any cross linked reaction products comprising an epoxy resin.

The terms “swelling” and “swell” should herein be taken to mean the entrance of a fluid (swelling fluid) into the material e.g. the thermoset epoxy matrix causing an increases in size and/or mass.

The term “slurry” should herein be taken to mean a flowable mixture of a fluid and thermoset epoxy fractions. Where the fluid consists of gas, the thermoset epoxy fractions may detach the fluid whereby the slurry consists of the thermoset epoxy fractions and optional remaining fluid

The term “maximal dimension” should herein be taken to mean, the maximal geometrical dimension of the composite structure determined as the outside-to-outside distance across the composite structure, e.g. the distance from turbine blade root to turbine blade tip.

The term “throbbing” should herein be taken to mean an exposure to mechanical stress, such as impacts experienced when shaken or repeatedly subjected to collision with a rigid element.

The term “step” means herein a procedure comprising one or more actions. Each step of the method may comprise any number of sub-steps, which may also be referred to as steps.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other features.

Throughout the description or claims, the singular encompasses the plural and the plural encompasses the singular unless otherwise specified or required by the context.

The “an embodiment” should be interpreted to include examples of the invention comprising the feature(s) of the mentioned embodiment.

The term “substantially” should herein be taken to mean that ordinary product variances and tolerances are comprised. All features of the invention and embodiments of the invention as described herein, including ranges and preferred ranges, may be combined in various ways within the scope of the invention, unless there are specific reasons not to combine such features.

Unless other is specified, any properties, ranges of properties and/or determination and/or assay condition (swelling condition) is given, determined or performed at 1 atmosphere (1.01325 Bar) and 25° C.

All features of the invention and embodiments of the invention as described herein including ranges and preferred ranges may be combined in various ways within the scope of the invention, unless such features are incombinable or presented as incombinable.

The method of the invention comprises extracting of thermoset epoxy fractions from a composite structure, wherein the composite structure comprises a thermoset epoxy matrix and one or more embedded solid elements. As explained the composite structure may be relatively large and may comprise several embedded solid elements of different structure or material as further described below.

The thermoset epoxy matrix has a network structure in which the embedded solid elements are partly or fully embedded.

The method comprises:
providing a swelling fluid
soaking the composite structure with the swelling fluid and allowing the thermoset epoxy matrix to swell the swelling fluid into the network structure of the thermoset epoxy matrix for a sufficient time to mechanically break up the network structure to form a multitude of thermoset epoxy fractions liberated from the solid element(s) and
separating at least a portion of the thermoset epoxy fractions from at least one of the solid element(s) to obtain a swelling fluid slurry comprising the portion of the thermoset epoxy fractions in the swelling fluid.

The swelling fluid comprises at least 1 mol/L of formic acid.

Formic acid also has the chemical name Methanoic acid. At 20° C. and 1 atm. it is in liquid form.

The desired concentration of formic acid in the swelling fluid may depend on the composition and/or crosslinking density of the thermoset epoxy matrix.

Advantageously, the swelling fluid comprises at least 3 mol/L of formic acid, such as at least 5 mol/L, such as at least 10 mol/L, such as at least 18 mol/L, such as at least 20 mol/L, such as at least 22 mol/L, such as at least 24 mol/L, such as at least 26 mol/L of formic acid.

The provision of the swelling fluid may comprise any number of steps, including purchasing a ready for use swelling fluid, such as an aqueous solution of formic acid.

Advantageously, the swelling fluid is an aqueous solution comprising the formic acid.

In an embodiment, the method comprises providing the swelling fluid to comprise additional components. The step of providing the swelling fluid may comprise mixing formic acid with one or more further components and optionally allow reaction components to be formed.

The additional component(s) may comprise the added further component(s) and/or reaction product(s) formed by addition of one or more of such added further component(s).

In an embodiment, the step of providing the swelling fluid comprises mixing formic acid with one or more additional components, optionally applying the formic acid in form of an aqueous solution.

The additional component(s) of the swelling fluid may in principle be any component that is compatible with the formic acid.

Examples of additional component(s) comprise at least one additional organic acid, such as acetic acid, trifluoroacetic acid, trichloroacetic acid, propionic acid, methanesulfonic acid, trifluoromethanesulfonic acid, performic acid, lactic acid, oxalic acid or anhydride of any of these.

In an embodiment the one or more additional components comprise at least one inorganic acid, such as hydrochloric acid, nitric acid, sulfuric acid, phosphoric acid, boric acid, and/or hydrobromic acid.

Further examples of additional component(s) comprise at least one alcohol, such as methanol, ethanol, propanol, isopropanol, butanol, t-butanol, and/or amyl alcohol.

In principle any alcohol, such as any liquid alcohol or any alcohol dissolvable in the swelling fluid may be used as an additional component, including primary alcohol, secondary alcohol and tertiary alcohol. When using alcohol as an additional component, a potential esterification of formic acid should advantageously be considered to ensure that the concentration of formic acid is at a desired level.

Further examples of additional component(s) comprise at least one additional solvent, such as tetrahydrofuran (THF), dimethylformamide (DMF), N-Methyl-2-pyrrolidone (NMP), dimethyl sulfoxide (DMSO), dichloromethane, chloroform, acetone, acetonitrile, chlorobenzene, diethylether, dioxane, ethylene glycol, polyethylene glycol (PEG), glycerin, hexamethylphosphoramide (HMPA), nitromethane, pyridine, trimethylamine, toluene, xylene, benzene, dimethylacetamide (DMAc), dimethoxyethane (DME), diglyme, and/or dichloroethan.

The one or more additional components may further comprise at least one dissolved salt, such as NaCl, KCl, CsCl, NaHCO₃, KHCO₃, CsHCO₃, Na₂CO₃, K₂CO₃, Cs₂CO₃, any salt comprising a quaternary ammonium cation, and/or any salt comprising either a tetrafluoroborate anion or hexafluorophosphate anion.

Adding salt to the swelling fluid may have the function of modifying the solubility of certain materials by the swelling fluid. For example where the swelling fluid is an aqueous swelling fluid, the addition of salt may alter hydrophobic effect of the swelling fluid. In an embodiment, the addition of salt to the swelling fluid, has the function of reducing the risk of disintegrating the embedded solid element(s), thereby ensuring the embedded solid element(s) are not disintegrated to small pieces that may be difficult to separate from the thermoset epoxy fractions.

In an embodiment, the additional component or additional components comprise(s) at least one surfactant, preferably selected from anionic and/or non-ionic surfactant, such as sulfates, sulfonates, gluconate, cocamide, ethoxylates, and/or alkoxylates.

Addition of surfactant may especially be desired where the swelling fluid is an aqueous swelling fluid and the composite structure is fully or partly covered by hydrophobic coating material or comprises internal layer(s) of hydrophobic coating material.

The type and amount of the at least one additional component may in an embodiment be selected in dependence of the embedded solid elements, for example to provide that the soaking of the composite structure in the swelling fluid does not provide any substantial solvation or disintegration of the embedded solid elements. Thereby the obtained thermoset epoxy fractions may be substantially or fully free of the embedded solid element or parts thereof.

In an embodiment, wherein the swelling fluid has a pH value of 2 or larger, such as between 2.5 and 4. The pH value may be selected to ensure a low risk of disintegrate or corrode the embedded solid element while simultaneously ensure an effective and relative fast swelling of the thermoset epoxy matrix.

The thermoset epoxy matrix may in principle be of any type, such as for example the epoxy composites described in “Introduction to Epoxy Composites: Fabrication, Characterization and Applications. Pages 1-21. First Edition. Published 2021 by WILEY-VCH GmbH.

It has been found that the method of the invention is very beneficial to apply where the thermoset epoxy matrix is highly cross-linked i.e. it has a high crosslinking density (the number of effective crosslinks per unit volume). Generally, the higher crosslinking degree the higher is the structural strength of the thermoset epoxy matrix. Therefore, composite structure obtained from large structural elements such as wind turbine blades, airplanes, ships, automobiles, bridge decking, boats, aircrafts and similar are most often of composite materials comprising thermoset epoxy matrix with a high crosslinking density. Surprisingly, the swelling fluid as used in the method of the invention is capable of effectively swelling into the network structure of the thermoset epoxy matrix having a relatively high crosslinking density and to mechanically break up the network structure to form the multitude of thermoset epoxy fractions.

The sizes of the thermoset epoxy fractions depend largely on the type of epoxy and the crosslinking density. The higher the crosslinking degree, i.e. the higher the number of crosslinks per volume unit of the thermoset epoxy matrix, the smaller will the thermoset epoxy fractions be. The average size (largest dimension) of the thermoset epoxy fractions may advantageously be 2 cm or less, such as 1 cm or less, such as 5 mm or less, or even 2 mm or less.

Advantageously, the thermoset epoxy fractions have an average size which is sufficient small to ensure at least 50% by weight, preferably at least 90% by weight of the thermoset epoxy fractions to pass a sieve with a nominal aperture size according to ISO 3310-1 2016 of 20 mm or larger, such as of 14 mm or larger. Advantageously, the thermoset epoxy fractions have an average size which is sufficient large to ensure at least 50% by weight, preferably at least 90% by weight of the thermoset epoxy fractions to do not pass a sieve with a nominal aperture size according to ISO 3310-1 2016 of 20 mm or smaller, such as of 10 mm or smaller, such as 5 mm or smaller, such as 2 mm or smaller.

The thermoset epoxy matrix of the composite structure comprises an epoxy based on at least one reactant comprising at least one epoxy resin, wherein epoxy resin has been cured.

The curing may be performed by any means, such as by irradiation (e.g. ionization, IR-radiation, e-beam etc.) and/or or by being subjected to at least one hardener, such as one or more anhydride curing agent, one or more thiol curing agent and/or one or more amine curing agent. Such curing agents are well known in the art.

The curing may be performed with or without external heating”. In addition, the curing may be performed at lowered pressure to shrink potential trapped air bubbles. In an embodiment, the curing comprises at step of vacuum degassing to remove such potentially trapped air bubbles prior to finalizing the curing process.

The at least one reactant may comprise two, three or more reactants as it is well known in the art.

The at least one reactant comprises at least one epoxy resin, such as liquid or solid Bisphenol A epoxy resins, Bisphenol F epoxy resins, epoxy novolac resins, cycloaliphatic epoxy resins, waterbased epoxy resins. Additional reactants may include reactive diluents, and curing agents. For example the curing agents offered by Aditya Birla Chemicals, e.g. curing agents comprising optionally modified phenalkamines, polyamides, aliphatic amines, cycloaliphatic amines, and waterborne curing agents. Reaktive diluents may for example comprise BDDGE (1,4-Butanediol diglycidyl ether), HDDGE (1,6-Hexanediol Diglycidyl Ether) and/or acrylates.

Further additives may comprise flow agents, accelerators, plasticizers and rheological additives.

Examples of epoxy forming the thermoset epoxy matrix comprises networks of components comprising at least one component selected from the groups of glycidyl ethers derived from Bis- or polyphenols, such as Bisphenol A, Bisphenol F, Bisphenol S, Bisphenol T, phenol or cresol; novolacs; cycloaliphatic, aliphatic, aromatic mono or poly alcohols, such as C12 and C16 fatty alcohols, 1,4 butanediol, 1,6 hexanediol, 1,4 cyclohexandimethanol, trimethylolpropane, glycerol, polyglycerol, pentaerythrol, sorbitol and o-cresol; glycidyl compound derived from aromatic amines such as p-amino phenol, aniline and methylene dianiline.

The thermoset epoxy matrix is conveniently cured by chemical reaction using a curing agent as described above under various pressure and temperature conditions depending on the chemical nature of the curing agent(s). the curing agent advantageously comprises at least one reactive moieties selected from carboxylic acid anhydrides, such as derivatives of phthalic acid anhydride or partially hydrogenated phthalic acid anhydride aromatic; aliphatic, cycloaliphatic, araliphatic mono or polyamines, such as methylendianiline, polyalkylenoxy mono or polyamine, polyalkylenpolyamine isophorondiamine and xylylendiamine; di or poly hydric phenols, such as advancement products of DGBPA (Bisphenol A diglycidyl ether) with BPA (Bisphenol A) or novolacs cyanamide like DiCy (dicyandiamide); and substituted ureas, such as monuron or diuron.

Recently recyclable epoxy comprising disulfide bridge moieties in the thermoset epoxy matrix were developed e.g. as described WO18050189. This epoxy is relatively simple to break down by cleaving at the disulfide bridges using a suitable solvent. However, such disulfide bridge containing epoxy is rarely used in today's large composite structures. In an embodiment, the thermoset epoxy matrix does not include a disulfide bridge moiety.

The method of the invention has shown to be exceptionally effective where the thermoset epoxy matrix is fully or partly cured by a hardener or a composition of hardener comprising at least one amine based hardener, such as an aliphatic amine based hardener, an aromatic amine based hardener and/or a multifunctional amine hardener such as the hardener described in U.S. Pat. No. 8,865,917B2.

Examples of suitable aliphatic amine based hardener comprises polyether amines, ethyleneamines such as DETA, TETA, etc, and cycloaliphatic amines such as PACM-H12MDI. Exemplary aromatic amines include DETDA, MBOEA, and other substituted methylene dianiline derivatives

The embedded solid elements may include any kind of solid element and it may serve different purposes. In an embodiment, the embedded solid elements comprise at least one of i) one or more reinforcement elements and ii) one or more support elements.

The support elements may comprise any elements that has practically no reinforcing function, such as filler, shaping aid, electrical component, lightning protections, coatings, such as paint, glue and/or core elements such as foams and/or woods.

In an embodiment, the embedded solid elements comprise at least one reinforcement layer, such as two or more reinforcement layers optionally glued together by the thermoset epoxy matrix, such as layers comprising one or more of fibers, metal, polymer, wood, ceramic, silicates and/or paint.

In an embodiment, the embedded solid elements comprise fibers selected from one or more of synthetic fiber, semi-synthetic fiber, regenerated fiber, plant fiber, carbon fiber, basalt fiber, glass fiber and/or metal fiber, the fiber may preferably be in the form of at least one sheet comprising fibers e.g. at least one sheet comprising fibers embedded in a polymer different from the thermoset epoxy matrix.

The fibers may advantageously form or form part of one or more reinforced elements. The synthetic fiber may comprise at least one of nylon, polyester, acrylic, polyvinyl chloride, polyurethane, vinylon, or aramid fiber. The semi-synthetic fiber may comprise at least one of acetate, triacetate, or promix fiber. The regenerated fiber may comprise at least one of rayon, cupro, or polynosic fiber. The plant fiber may comprise at least one of cotton or hemp fiber. The carbon fiber comprises at least one of pure carbon or pitch carbon. The metal fiber comprises at least one of silver or steel fiber.

In an embodiment the fibers comprise glass-, synthetic-, carbon-, plant-, and/or metal-fibers. The fibers may advantageously be present in the form of woven or non-woven mats, or comprise strings or fibers chopped to shortened length. The fibers may advantageously be present as one or multiple layers bonded together by a thermoset matrix which may be the thermoset epoxy matrix or a thermoset matrix of a non-epoxy type. In an embodiment, the fibers may be coated e.g. with a primer. Such primers are generally known as sizing agents.

In an embodiment, the fibers comprise glass fibers, such as E-glass fibers which is alumino-borosilicate glass with low amount of alkali oxides. The glass fibers may conveniently be coated e.g. with a resin coating and/or a silane coupling agents for increasing the interfacial strength between the glass fibers and the thermoset epoxy matrix. An example of a silane coupling agent includes an epoxy functionalized organosilane or 3-glycidyloxypropyl trimethoxysilane (GPTMS).

The fibers may advantageously be present in the form of woven or non-woven mats and/or in the form of bundles and/or rovings. In an embodiment, the thermoset epoxy matrix comprises multiple layers of fiber mats bonded together mechanically or chemically e.g. by a glue such as a thermoset matrix which may be a thermoset epoxy matrix or a thermoset non-epoxy matrix.

In an embodiment, the embedded solid element(s) comprises chopped glass fibers and/or hollow glass beads.

In an embodiment, the embedded solid element(s) comprises wood, such as balsa.

Balsa is a biological material which is highly suitable for forming a core in a sandwich construction of a composite structure it has an extremely high strength and stiffness to weight ratio, and achieves an excellent bond with all types of resins and adhesives. Further info about balsa and its use in “Review of balsa core sandwich composite structures” by Joel Galos et al. Materials & Design. Volume 221 (September 2022) 111013. Elsevier Ltd. https://doi.org/10.1016/j.matdes.2022.111013.

In an embodiment, the embedded solid element(s) comprises foamed plastic such as foamed plastic comprising at least one of polystyrene (PS), polyurethane (PU), poly(vinyl chloride) (PVC), polyethylene terephthalate (PET), polyolefins (polyethylene (PE) and polypropylene (PP)) and ABS foams, preferably the foamed plastic is rigid.

The foamed plastic is advantageously a closed cell foam.

The foamed plastic advantageously has a high fire resistance and ensure a light weight of the composite structure, which may be required in some applications. PVC specifically has a high stiffness and strength to weight ratio. The PVC may conveniently be cross-linked. Also, other polymer foams have excellent mechanical properties, such as PET and PU.

In an embodiment, the reinforcement elements comprise metal, such as steel, aluminum, titanium, chromium, cobalt, nickel, copper, zinc, tin, lead and any alloys comprising at least one of the before mentioned, preferably the metal is in the form of wire(s) and/or grids of metal. In an embodiment, the reinforcement comprises metal fibers and/or a metal girder.

In an embodiment, the embedded solid elements comprise at least one additional thermoset matrix comprising comprises cross-linked polyester, polyurethane, vulcanized rubber, cross-linked polyvinylester, cross-linked polyimides, cross-linked phenol-formaldehyde, cross-linked polybenzoxazine, cured amino resin, cured furan resin, cured maleimide resin, or cured silicone or any combinations comprising at least one of the before mentioned.

The term “additional thermoset matrix” means a thermoset polymer matrix in addition to the thermoset epoxy matrix of the composite structure. The additional thermoset matrix may conveniently be a non-epoxy thermoset polymer matrix i.e. a thermoset polymer matrix without epoxide based crosslinks.

The step of soaking the composite structure with the swelling fluid may be performed at any temperature. Preferably the step of soaking the composite structure is performed with the formic acid in liquid form. Preferably below the boiling point and above the freezing point of the formic acid, which at 1 atm. is below 105° C. and above −5° C. for a 90% w/w aqueous formic acid solution (23.9 mol/L).

In an embodiment, the step of soaking the composite structure with the swelling fluid is performed at a temperature of the swelling fluid up to 100° C., such as from 8° C. to 75° C., such as from 10° C. to 50° C., such as from 20° C. to 35° C., such as 22° C. to 27° C. of the swelling fluid.

Advantageously, the step of soaking the composite structure with the swelling fluid is performed at ambient temperature or slightly raised temperature, such as from 20-25° C. Thereby, the cost may be kept low since no heating of the swelling fluid may be required. It has been found the method of the invention is very effective even at relative low temperature, however where the temperature is at ambient temperature or higher the swelling rate may increase with increased temperature.

The step of soaking the composite structure with the swelling fluid may conveniently be performed at atmosphere pressure. Thereby the equipment used need not be fully gas tight.

In an embodiment, the step of soaking the composite structure with the swelling fluid is at least partly performed at elevated pressure, such as up to a pressure of 3 bar, such as up to a pressure of 2 bar, such as up to a pressure of 1.5 bar.

The elevated pressure may conveniently be reached by performing the step of soaking the composite structure in a closed treatment container and then raising the temperature until the desired temperature and pressure are reached.

The contact between the composite structure and the swelling fluid during the step of soaking the composite structure with the swelling fluid may be performed by any method.

In an embodiment, the step of soaking the composite structure with the swelling fluid comprises contacting the composite structure with the swelling fluid in a treatment container. The treatment container may in an embodiment be an open container, such as a container with an opening for supplying or withdrawing the composite structure or parts thereof. Where the treatment container is open during the treatment process, the treatment container, or the area immediately around the treatment container, may advantageously comprise suitable protection arrangement for protecting potential operators or observers of the process. The container may advantageously be a closed or a closable container.

In an embodiment, the step of soaking the composite structure with the swelling fluid comprises arranging the composite structure in a volume of the swelling fluid in a treatment container and/or sprinkling the composite structure with the swelling fluid in a treatment container. The treatment container may be as described above.

In an embodiment, the step of soaking the composite structure with the swelling fluid comprises transporting the composite structure through a treatment location stepwise or continuously where the composite structure is treated with the swelling fluid e.g. by sprinkling at the treatment location. The method may for example comprise arranging the composite structure on a conveyor belt and transporting the composite structure through a treatment container where it is treated with the swelling fluid e.g. by sprinkling. The use of sprinkling for the soaking step may be advantageous in that the amount of swelling fluid used may be relatively low, in that the swelling fluid may repeatedly be recirculated.

The step of soaking the composite structure with the swelling fluid may conveniently comprise contacting the composite structure with the swelling fluid for a period (soaking time) of up to 144 hours, such as from 1 to 130 hours, such as from 10 hour to 100 hours, such as from 24 to 96 hours, for example up to 72 hours, such as up to 48 hours. The desired soaking time depend on several factors, such as the type of thermoset epoxy matrix of the composite structure, the crosslinking degree of the thermoset epoxy matrix, the size of the composite structure, the shape of the composite structure, the temperature and the pressure during the soaking step, the composition of the swelling fluid as well as the performance of the soaking step.

Thus, it has been found that by subjecting the composite structure to mechanical influences during at least a part of the soaking step may reduce the desired soaking time.

In an embodiment, the step of soaking the composite structure with the swelling fluid comprises subjecting the composite structure and/or the swelling fluid to mechanical influences comprising vibrations e.g. using ultrasound and/or subjecting swelling fluid to motions e.g. using stirring/shaking and/or blowing gas through the swelling fluid.

The step of separating the thermoset may be performed in any suitable way.

In an embodiment, the step of separating the thermoset epoxy fractions from the solid elements, comprises separating the solid elements and the swelling fluid by withdrawing the swelling fluid from the solid elements to obtain the swelling fluid slurry or by removing the solid elements from the swelling fluid to obtain the swelling fluid slurry. The swelling fluid may for example be withdrawn from the solid elements by pumping out of the swelling fluid or by filtering using a filter with a large pore size to allow thermoset epoxy fractions to pass together with the swelling fluid to thereby obtain a slurry comprising at least a portion of the thermoset epoxy fractions, while holding back the solid elements.

In an embodiment, the step of separating the thermoset epoxy fractions from the solid elements comprises shaking, such as mechanically vibrating the solid elements to liberate thermoset epoxy fraction.

In an embodiment, the step of separating the thermoset epoxy fractions from the solid elements, comprises subjecting the solid elements to at least one washing process. The washing process may conveniently comprise washing the previously embedded solid elements using a washing fluid to obtain a washing fluid slurry comprising at least a portion of the thermoset resin fractions in the washing fluid. The washing fluid may in an embodiment be water, such as tap water. Advantageously, the washing fluid comprises a surfactant, wherein the surfactant preferably comprises an anionic surfactant and/or an amphiphilic surfactant, such as a quaternary ammonium surfactant.

The surfactant act to reduces surface tension of the solid elements and thereby increasing its wetting properties to separate the thermoset epoxy fractions from the solid elements.

In an embodiment, the step of separating the thermoset epoxy fractions from the solid elements comprises subjecting the solid elements to at least one flushing process. The flushing may advantageously be a high pressure flushing, using a flushing fluid selected from a flushing gas, a flushing liquid or a mixture thereof. Thereby a flushing fluid slurry comprising at least a portion of the thermoset resin fractions in the flushing fluid may be obtained.

Where the flushing fluid consists of flushing gas, the thermoset resin fractions may detach from the flushing fluid immediately after being separated from the solid elements. Thereby the flushing fluid slurry is provided by the detached thermoset epoxy fractions.

The flushing fluid is advantageously water or water containing a surfactant, such as an anionic surfactant and/or an amphiphilic surfactant, such as a quaternary ammonium surfactant.

Where both a washing process and a flushing process of the solid elements are performed, the obtained washing fluid slurry and the obtained flushing fluid slurry may be mixed to a combined slurry e.g. for further processing as described below.

In an embodiment, the step of separating the thermoset epoxy fractions from the solid elements comprises mechanically deforming the solid elements, such as crushing the solid elements and/or throbbing the solid elements.

Such step of mechanically deforming the solid elements may conveniently be performed prior to the washing process and/or prior to the flushing process. Alternatively, an additional washing process and/or an additional flushing process may be performed after or simultaneously with mechanically deforming the solid elements. The obtained washing fluid slurry and/or the obtained flushing fluid slurry may conveniently be added to form part of the combined slurry.

In an embodiment, the step of separating the thermoset epoxy fractions from the solid elements, further comprises mechanically removing thermoset epoxy fractions from the solid elements, e.g. by scraping and/or combing.

Such step of mechanically removing thermoset epoxy fractions from the solid elements may conveniently be performed prior to the washing process and/or prior the flushing process. Alternatively, an additional washing process and/or an additional flushing process may be performed after or simultaneously with mechanically removing thermoset epoxy fractions from the solid elements. The obtained washing fluid slurry and/or the obtained flushing fluid slurry may conveniently be added to form part of the combined slurry.

The step of separating the thermoset epoxy fractions from the solid elements may further comprises filtering, such as filtering of the washing fluid slurry, flushing fluid slurry and/or the combined slurry. Thereby, at least a portion of the thermoset epoxy fractions from the washing fluid slurry and/or the flushing fluid slurry and/or the combined slurry may be obtained.

In an embodiment, the method further comprises filtering the swelling fluid slurry to collect at least a portion of the thermoset epoxy fractions from the swelling fluid slurry, wherein the method preferably further comprises recirculating the swelling fluid e.g. for use in the method of extracting of thermoset epoxy fractions from a composite structure as described above.

Where the swelling fluid is recirculated, the concentration of formic acid may advantageously be adjusted since formic acid is hygroscopic and tends to absorb moisture from the air which may result in reducing the formic acid concentration. In addition, formic acid over time decomposes to carbon monoxide and water, which may also influence the formic acid concentration.

In an embodiment, the method comprises subjecting the collecting portion(s) of thermoset epoxy fractions to a further washing step and/or drying the portion(s) of thermoset epoxy fractions.

Such a further washing step may for example have the function of removing fractions of the solid elements, such small fractions of paint or fibers.

The resulting thermoset epoxy fractions may be stored for later use e.g. for depolymerisation.

In an embodiment, the method further comprises subjecting the thermoset epoxy fractions to a step of depolymerisation, e.g. using good solvent of NMP (N-Methyl-2-pyrrolidone)), the organic catalyst Triazabicyclodecene (TBD), and the alcohol ethylene glycol (EG).

The depolymerisation may be performed using any method, such as the method known in the art, e.g. as described in “Recycling of Epoxy Thermoset and Composites via Good Solvent Assisted and Small Molecules Participated Exchange Reactions”, by Xiao Kuang et al. ACS Sustainable Chem. Page 1-27. Eng DOI: 10.1021/acssuschemeng.8b01538—Publication Date (Web): 29 May 2018. https://pubs.acs.org/doi/10.1021/acssuschemeng.8b01538.

By using the thermoset epoxy fractions as the starting point for the depolymerisation, the depolymerisation becomes very fast and effective and the obtained depolymerized components including epoxy oligomers may be obtained with a desired high purity.

The method of the invention may be performed even using relatively large composite structures. Advantageously, the composite structure has a maximal dimension of at least 0.1 m, such as at least 1 m, such as at least 5 m, such as at least 10 m, such as from 15 to 200 m, such as from 20-100 m.

Examples of composite structures from which the extracting of thermoset epoxy fractions may be performed may include an entire or a portion of a wind turbine blade, an airplane, a ship, an automobile, a bridge decking, a boat, an aircraft and/or a circuit board.

In an embodiment, the composite structure is obtained from a wind turbine blade comprising a spar cap as described in WO2022/188934.

The limiting size of the composite structure is in principle the size of the treatment container.

Thus, in an embodiment the composite structure is an entire wind turbine blade. In an embodiment, the composite structure is half of a wind turbine blade. In an embodiment, the composite structure is 1/10 or more of a wind turbine blade.

### BRIEF DESCRIPTIONS OF EMBODIMENTS AND EXAMPLES

In the following the invention will be further illustrated by the description of a number of illustrative and non-limiting embodiments and examples of the present invention, with reference to the appended drawings.

The figures are schematic and are not drawn to scale and may be simplified for clarity. Throughout, the same reference numerals are used for identical or corresponding parts.

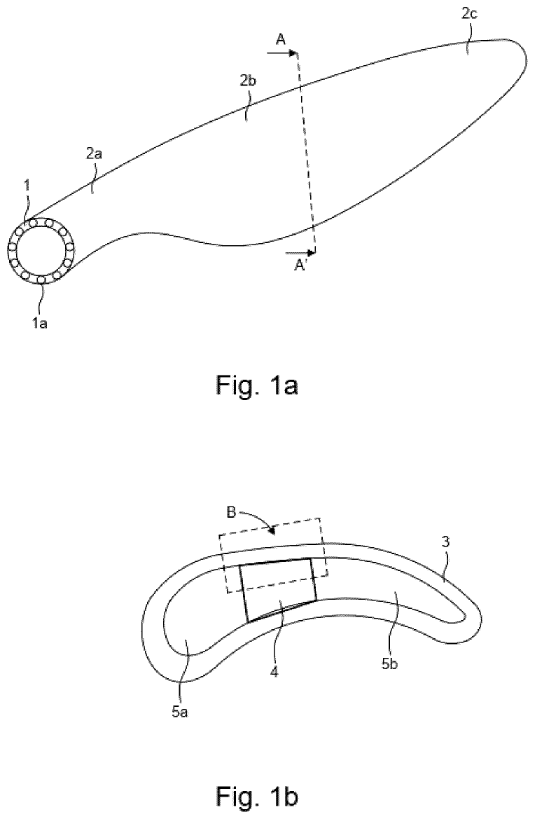

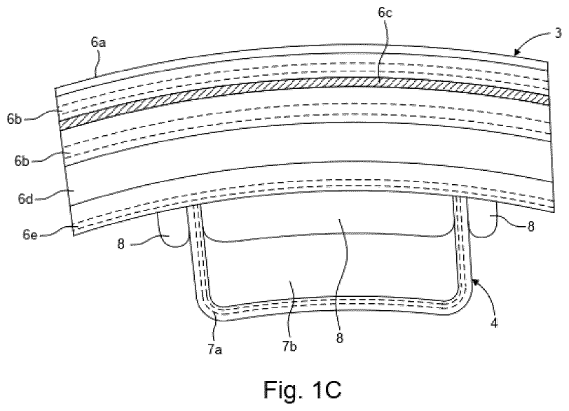

FIG. 1a is a schematic illustration of a composite structure in the form of a wind turbine blade.

FIG. 1b is a cross sectional view of the wind turbine blade of FIG. 1a seen in the cross sectional line A-A′.

FIG. 1c is a close up view of the section B of the cross sectional view seen in FIG. 1b.

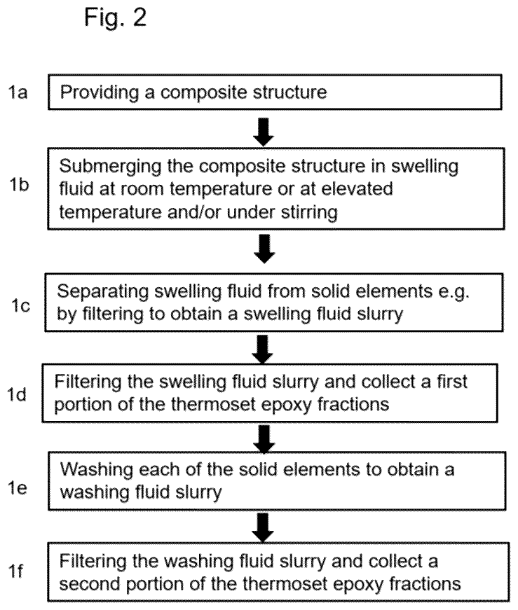

FIGS. 2-5 are process diagrams of different examples of processes for carrying out the method of the invention.

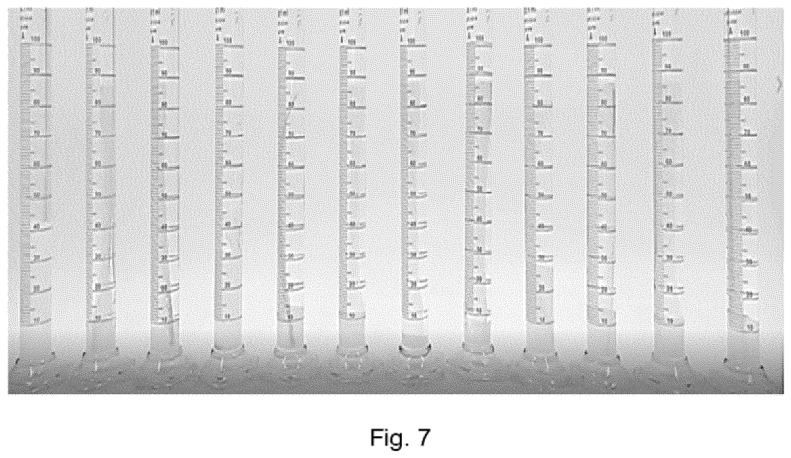

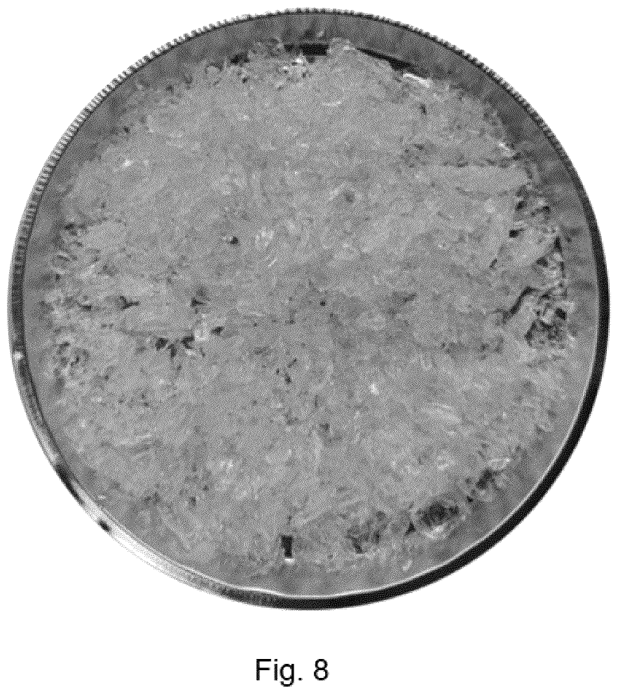

FIGS. 7 and 8 are images associated to example 3.

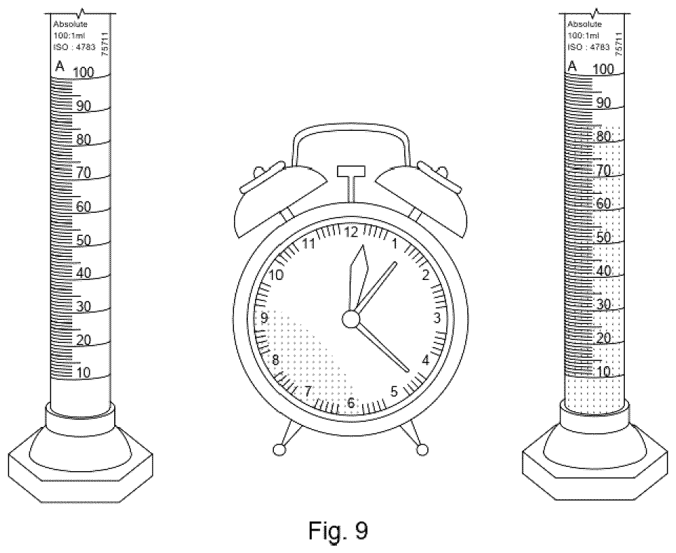

FIGS. 9, 10 and 11 are respectively images and a graph associated to example 4.

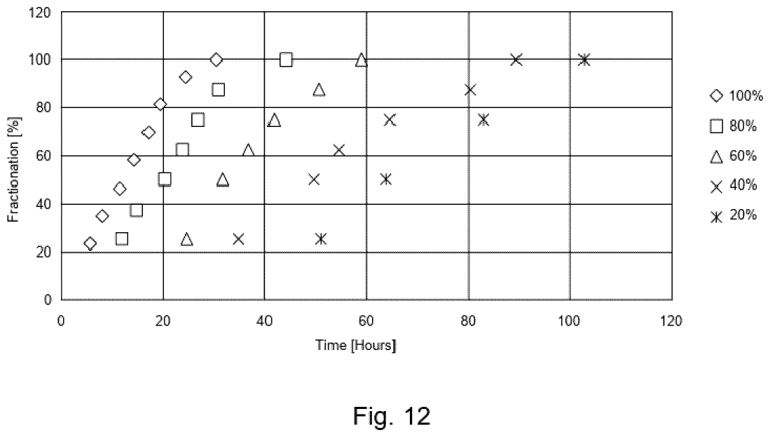

FIG. 12 is a graph associated to example 5.

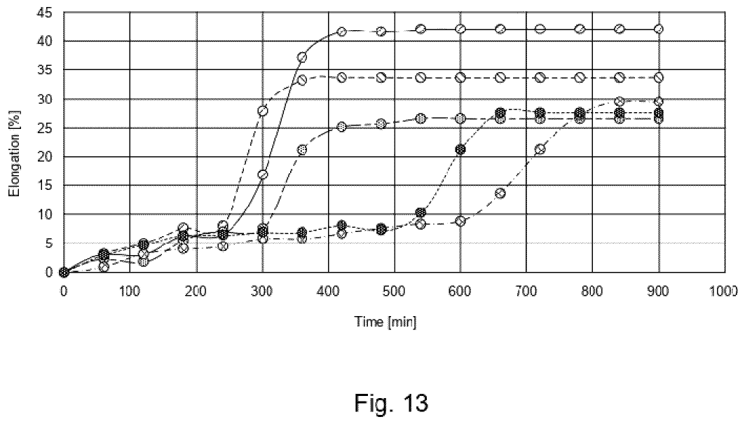

FIGS. 13 and 14 are respectively a graph and an image associated to example 6.

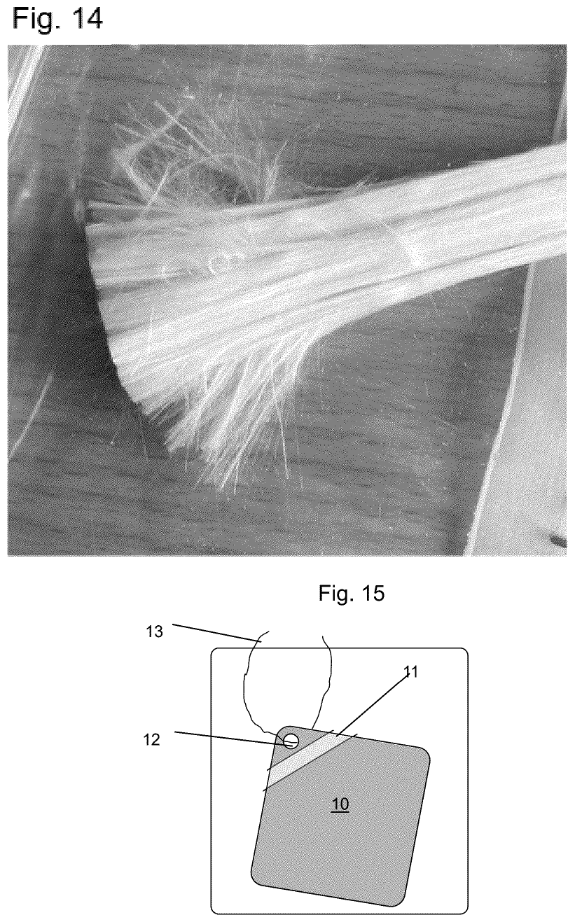

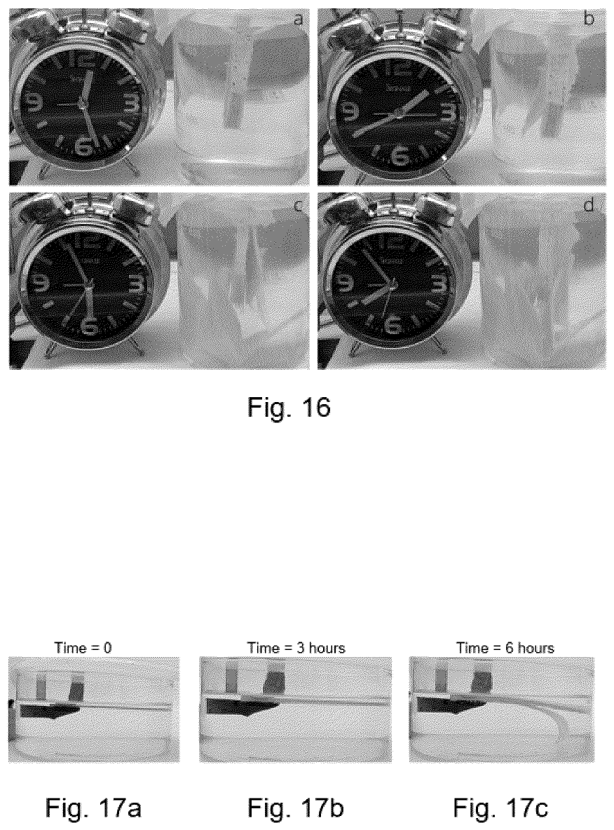

FIGS. 15 and 16 (a-d) are respectively a figure and images associated to example 7.

FIGS. 17a-17c are illustrations associated to example 20.

The composite structure shown in FIG. 1a is an example of a wind turbine blade obtained from a wind turbine. Most state of art wind turbines comprises a rotor with three wind turbine blades. It should be understood that the composite structure could be the entire or a part of any kind of wind turbine blade comprising composite material.

The shape of the wind turbine blade is often referred to as an airfoil shape and comprises a root portion 2a, a curved midspan portion 2b and a tip portion 2c.

The wind turbine blade has an edge 1 where it is cut from or demounted from the remaining part of the wind turbine. At the edge 1 is seen a number of reinforcement beams 1a which ensure a strong connection of the neck portion 2a to the remaining part of the wind turbine.

FIG. 1b is a cross sectional view of the wind turbine blade of FIG. 1a seen in the cross sectional line A-A′ taking in the midspan 2b of the wind turbine blade. In the shown example the wind turbine blade has a shell structure 3, a structural unit 4 and a first hollow space 5a and a second hollow space 5b.

The first hollow space 5a and the second hollow space 5b may coincide at the tip portion 2c of the wind turbine blade. The first hollow space 5a and/or the second hollow space 5b may comprise additional not shown structural elements, such as foamed polymer and optionally a portion of the thermoset epoxy matrix.

In FIG. 1c is a close up view of the section B of the cross sectional view seen in FIG. 1b. In the shown example the shell structure 3 comprises from outside and inwards a paint layer 6a optionally cowered with a not shown repelling layer and/or erosion protecting layer for protecting the wind turbine blade. Below the paint layer 6a, the shell structure 3 comprises a first composite structure 6b comprising one or more layers of glass fibers embedded in the thermoset epoxy matrix. A lightning protecting grid 6c is embedded in the first composite structure 6b. Below the first composite structure 6b, the shell structure 3 comprises a core material 6d, such as of balsa or of a closed celled polymer foam—e.g. PVC or a combination thereof. Below the core material 6d, the shell structure 3 comprises a second composite structure 6e comprising one or more layers of glass fibers embedded in the thermoset epoxy matrix. The core material 6d may be embedded in the thermoset epoxy matrix between the first composite structure 6b and the second composite structure 6e.

The structural unit 4 comprises at least one composite layer 7a comprising one or more layers of glass fibers embedded in the thermoset epoxy matrix. The at least one composite layer 7a at least partly surrounds a core 7b of the structural unit 4. The core 7b may be of any material. In this example the core 7b is of core material such as of balsa or of a closed celled polymer foam—e.g. PVC or a combination thereof. It should be understood that the structural unit as well as the other embedded solid element of the shown wind turbine blade is an example and may vary from other wind turbine blades.

In the shown example, the structural unit 4 is glued to the shell structure 3 by an excess amount of glue 8. The glue may be epoxy, whereby the glue form part of the thermoset epoxy matrix.

FIG. 2 show a first example of carrying out the method of the invention. In step 1a, a composite structure is provided. The composite structure may be as described above. In step 1b the composite structure is submerged in a swelling fluid comprising formic acid as described above, wherein the swelling fluid is at either room temperature, or at elevated temperature e.g. as described above, such as at a temperature of the swelling fluid of about 25° C. such as about 35° C., such as about 50° C., such as about 80° C., or such as about 95° C. The swelling fluid may e.g. be kept at this temperature through the entire soaking process or it may be allowed to gradually cool down. During the soaking process the swelling fluid may be subjected to stirring or shaking.

In step 1c, the swelling fluid is separated from the solid elements e.g. as described above and preferably by filtering to obtain a swelling fluid slurry comprising a slurry of thermoset epoxy fractions in the swelling fluid.

In step 1d, the swelling fluid slurry is filtered to obtain a first portion of the thermoset epoxy fractions. Thereafter, in step 1e, each of the solid elements are washed using a washing fluid to obtain a washing fluid slurry. The respective solid elements may conveniently be washed using respective portions of the washing fluids which thereafter may be combined to obtain the washing fluid slurry.

In step 1f, the washing fluid slurry is filtered and a second portion of the thermoset epoxy fractions is collected.

The first portion and the second portion of thermoset epoxy fractions may conveniently be mixed and be subjected to further process such as depolymerisation as described above.

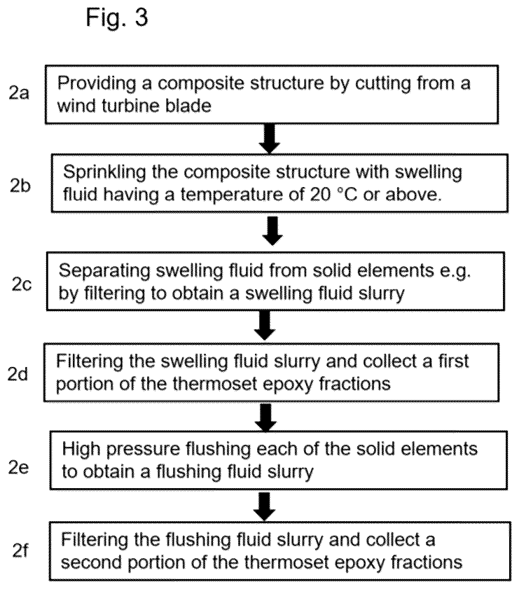

FIG. 3 shows a second example of carrying out the method of the invention.

In step 2a, a composite structure in the form of a composite structure cut from a wind turbine blade is provided. The wind turbine blade may e.g. be as shown in FIGS. 1a-1c.

In step 2b, the composite structure is sprinkled with a swelling fluid, such as the swelling fluid described above. The swelling fluid is maintained at a temperature above 20° C., such as about 50° C., such as about 80° C., or such as about 95° C. After a suitable swelling period of being contacted by the swelling fluid, e.g. the swelling period described above, the swelling fluid is in step 2c separated from the solid elements e.g. as described above and preferably by filtering to obtain a swelling fluid slurry comprising a slurry of thermoset epoxy fractions in the swelling fluid.

In step 2d, the swelling fluid slurry is filtered to obtain a first portion of the thermoset epoxy fractions. Thereafter, in step 2e, each of the solid elements are subjected to a high pressure flushing using a flushing fluid to obtain a flushing fluid slurry. The respective solid elements may conveniently be flushed using respective portions of the flushing fluids which thereafter may be combined to obtain the flushing fluid slurry.

In step 2f the flushing fluid slurry is filtered and a second portion of the thermoset epoxy fractions is collected.

The first portion and the second portion of thermoset epoxy fractions may conveniently be mixed and be subjected to further process such as depolymerisation as described above.

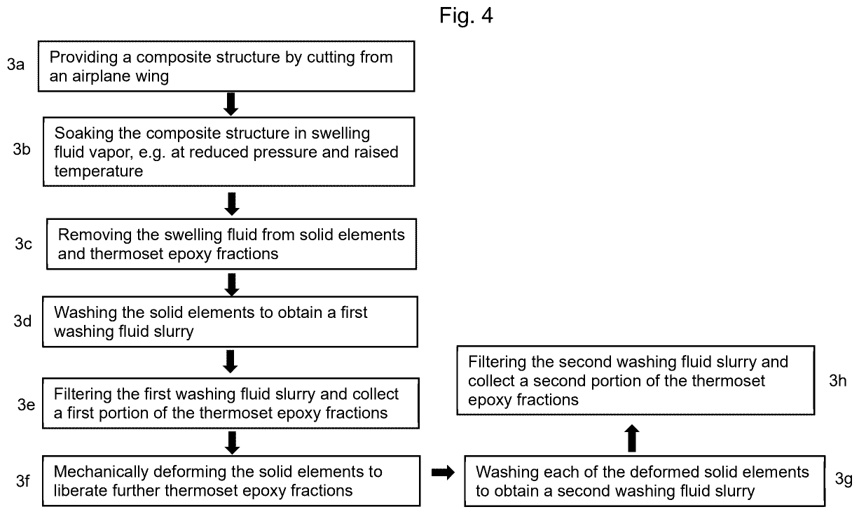

FIG. 4 shows a third example of carrying out the method of the invention.

In step 3a, a composite structure in the form of a composite structure cut from an air plane wing is provided.

In step 3b, the composite structure is soaked in swelling fluid vapor. The swelling fluid may be described above in vaporized state. The swelling fluid vapor may conveniently be at reduced pressure and/or at elevated temperature, such as about 80° C., such as about 90° C., or such as about 100° C. After a suitable swelling period of being contacted by the swelling fluid, e.g. the swelling period described above, the swelling fluid is in step 3c removed from the solid element, preferably by withdrawing/pumping out the swelling fluid vapor from the treatment container. Thereby the solid elements and the thermoset epoxy fractions remain in the treatment container.

In step 3d, the solid elements are washed using a first washing fluid to obtain a first washing fluid slurry. The washing may conveniently be performed with the solid elements remaining in the treatment container.

In step 3e, the first washing fluid slurry is filtered and a first portion of the thermoset epoxy fractions is collected.

In step 3f, the respective solid elements are removed from the treatment container and each of the respective solid elements are subjected to a deformation treatment e.g. as described above to liberate further thermoset epoxy fractions.

In step 3g, each of the deformed solid elements are washed using a second washing fluid to obtain a second washing fluid slurry. The respective deformed solid elements may conveniently be washed using respective portions of the second washing fluid, which portions thereafter may be combined to obtain the second washing fluid slurry.

In step 3h, the second washing fluid slurry is filtered and a second portion of the thermoset epoxy fractions is collected.

The portions of thermoset epoxy fractions may be combined as described above.

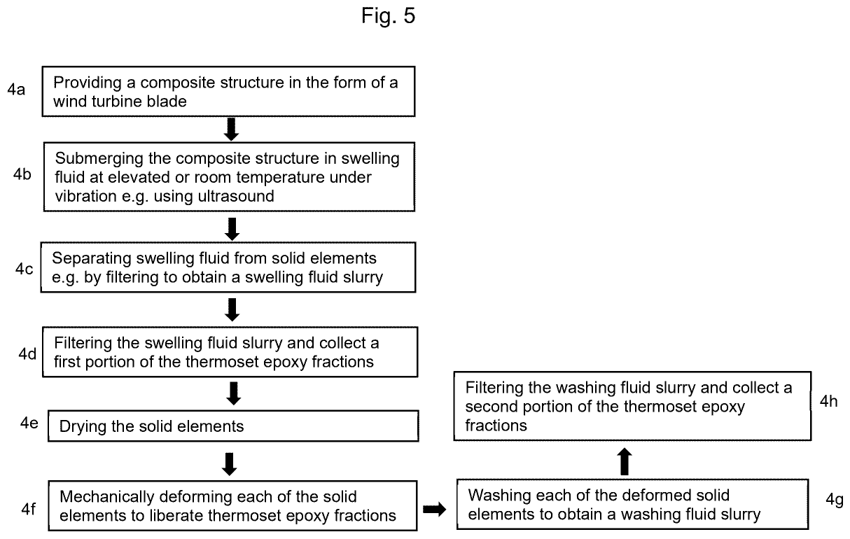

FIG. 5 shows a fourth example of carrying out the method of the invention.

In step 4a, a composite structure in the form of a wind turbine blade is provided. The wind turbine blade may e.g. be as shown in FIGS. 1a-1c.

In step 4b, the composite structure is submerged in a swelling fluid comprising formic acid as described above, wherein the swelling fluid is at either at room temperature or at elevated temperature and is under vibrations e.g. provided by ultrasound. The temperature of the swelling fluid may conveniently be as described above, such as at a temperature of the swelling fluid of about 50° C., such as about 80° C., or such as about 95° C. The swelling fluid may e.g. be kept at this temperature through the entire soaking process or it may be allowed to gradually cool down.

After a suitable swelling period of being contacted by the swelling fluid, e.g. the swelling period described above, the swelling fluid is in step 4c separated from the solid elements e.g. as described above and preferably by filtering to obtain a swelling fluid slurry comprising a slurry of thermoset epoxy fractions in the swelling fluid.

In step 4d, the swelling fluid slurry is filtered to obtain a first portion of the thermoset epoxy fractions. Thereafter, in step 4e, the solid elements are dried.

In step 4f, the respective solid elements are subjected to a deformation treatment e.g. as described above to liberate further thermoset epoxy fractions.

In step 4g, each of the deformed solid elements are washed using a washing fluid to obtain a washing fluid slurry. The respective deformed solid elements may conveniently be washed using respective portions of the washing fluid, which portions thereafter may be combined to obtain the washing fluid slurry.

In step 4h, the washing fluid slurry is filtered and a second portion of the thermoset epoxy fractions is collected.

The portions of thermoset epoxy fractions may be combined as described above.

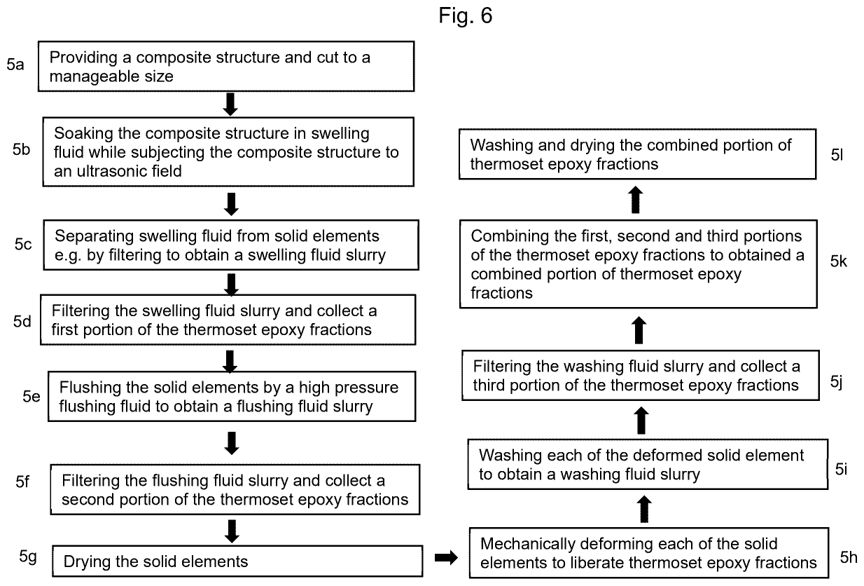

FIG. 6 shows a fifth example of carrying out the method of the invention.

In step 5a, a composite structure is obtained e.g. as described above and cut to a manageable size. As described above, the maximal manageable size depend on the size of the treatment container.

In step 5b, the composite structure is submerged in a swelling fluid comprising formic acid as described above, wherein the swelling fluid is at elevated temperature and the composite structure is subjected to an ultrasonic field.

The temperature of the swelling fluid may conveniently be as described above, such as at a temperature of the swelling fluid of about 50° C., such as about 80° C., or such as about 95° C. The swelling fluid may e.g. be kept at this temperature through the entire soaking process or it may be allowed to gradually cool down.

After a suitable swelling period of being contacted by the swelling fluid, e.g. the swelling period described above, the swelling fluid is in step 5c separated from the solid elements e.g. as described above and preferably by filtering to obtain a swelling fluid slurry comprising a slurry of thermoset epoxy fractions in the swelling fluid.

In step 5d, the swelling fluid slurry is filtered to obtain a first portion of the thermoset epoxy fractions.

Thereafter, in step 5e, the solid elements are subjected to flushing using a high pressure flushing fluid to obtain a flushing fluid slurry.

The solid elements may be subjected to the flushing in the treatment container and/or the respective solid elements may be flushed using respective portions of the flushing fluids, which thereafter may be combined to obtain the flushing fluid slurry.

In step 5f, the flushing fluid slurry is filtered and a second portion of the thermoset epoxy fractions is collected.

In step 5g, the solid elements are dried, where after, in step 5h, the respective solid elements are subjected to a deformation treatment e.g. as described above to liberate further thermoset epoxy fractions.

In step 5i, each of the deformed solid elements are washed using a washing fluid to obtain a washing fluid slurry.

The respective deformed solid elements may conveniently be washed using respective portions of the washing fluid, which portions thereafter may be combined to obtain the washing fluid slurry.

In step 5j, the washing fluid slurry is filtered and a third portion of the thermoset epoxy fractions is collected.

The portions of thermoset epoxy fractions is thereafter, in step 5k, combined to obtain a combined portion of thermoset epoxy fractions.

In step 5l, the combined portion of thermoset epoxy fractions is washed and dried. The dry combined portion of thermoset epoxy fractions may be stored for later use or further processing as described above.

### EXAMPLES

In the following is provided a number of illustrative and non-limiting examples of the invention

### Example 1: Preparation of Standard Epoxy Clear Cast Dogbones

100.00 g epoxy resin (commercially available) was hand-mixed with 30.00 g hardener (commercially available) in an aluminum foil tray. The mixture was subsequently degassed for at least 20 min under vacuum in a desiccator until bubbles were no longer observed. The mixture was poured into a silicone mold and cured at 50° C. for 1 hour and then post-cured at 80° C. for 3 hours.

### Example 2: Experiment with Clear Cast Epoxy Dogbone in Beaker

A clear cast epoxy dogbone as prepared in example 1 was added to a 250 mL beaker. Formic acid (100% by volume (v/v %)) was added to the beaker. It was observed that the dog bone started to fractionate under noise from the breaking material, and lead to sedimentation in to the glass, showing as a buildup of fractionated epoxy depositing to the bottom of the beaker as a slurry.

### Example 3: Measurement of Fractionation Rate

Fractionation rates were measured using standard epoxy clear cast dogbones as prepared in example 1. Each dogbone was set in a 100 mL measuring cylinder with volume marking on the glassware for each mL. At time=0 minutes, a swelling fluid (78 v/v %) was poured over the dogbones. A timelapse video camera was set to record the fractionation progress. During fractionation, grains of cured epoxy resin was dislocated from the samples and sediments as a slurry in the bottom of the measuring glass. Fractionation progression (measured in %) at respective elapsed periods of time of the experiment from pouring the liquid solvent over the dogbones, was defined as a powder volume reached at an elapsed period of time divided with an end volume reached of the respective sample, which end volume was determined as a plateau after sufficient elapsed time i.e. the fractionation progress has reached a maximum.

FIG. 7 shows an image taken mid-experiment as an example of the experimental setup when measuring fractionation rates, in this case of 12 different clear cast epoxy formulations in a swelling fluid in the form of an aqueous formic acid solution (78 v/v %).

FIG. 8 is a picture of the thermoset epoxy fractions, after being filtered from the swelling fluid, and dried for 24 hours in vacuo. The thermoset epoxy fractions as a sample after ended experiment when measuring fractionation rate of different formulations of clear cast epoxy.

### Example 4: Measurement of Fractionation Rate with Other Acids

Fractionation rates were measured using standard epoxy clear cast dogbones as prepared in example 1. Each dogbone was set in a 100 mL measuring cylinder with volume marking on the glassware for each mL. At time=0 minutes, a liquid solvent was poured over the dogbones. A timelapse video camera was set to record the fractionation progress. If fractionation occurs, grains of cured epoxy resin was dislocated from the samples and deposits as a slurry in the bottom of the measuring glass. Fractionation progression (measured in %) at respective elapsed periods of time of the experiment from pouring the liquid solvent over the dogbones, was defined as a powder volume reached at an elapsed period of time divided with an end volume reached of the respective sample, which end volume was determined as a plateau after sufficient elapsed time i.e. the fractionation progress has reached a maximum. Solutions investigated includes: a swelling fluid of formic acid (75 v/v % in water), acetic acid (75 v/v % in water), propionic acid (75 v/v % in water), lactic acid (75 v/v % in water), hydrochloric acid (37 v/v % in water) and sulfuric acid (50 v/v % in water).

From this experiment it was possible to extract an approximate rate of degradation for such specimen in this medium, revealing that swelling fluid comprising formic acid leads to a swelling induced fractionation with an approximately 11-fold acceleration compared to using a solvent with acetic acid, and that even larger compared to using solvent with other acids such as propionic acid and lactic acid, which also induce fractionation, however, at a significantly slower rate than swelling fluid comprising formic acid. For example, after 300 hours the fractionation rate using solvent with lactic acid was practically zero.

FIG. 9 illustrates an example of a timed experiment with clearcast epoxy dogbones in either (left) a swelling fluid comprising formic acid and (right) a corresponding solution of acetic acid.

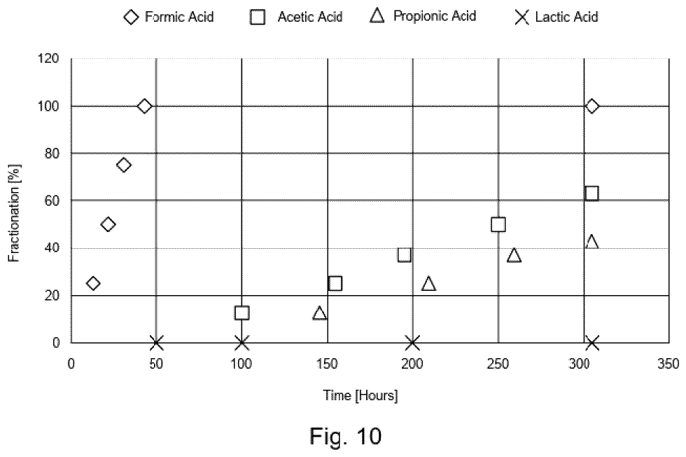

FIG. 10 is a graph comparing the degree of fractionation reached for clear cast epoxy dogbones after an elapsed time of experiment measured in hours, in solutions containing 75 v/v % acid in water. Investigated acids: formic acid, acetic acid, propionic acid, lactic acid. These results reveal a significantly faster fractionation rate of formic acid compared to all the other acids.

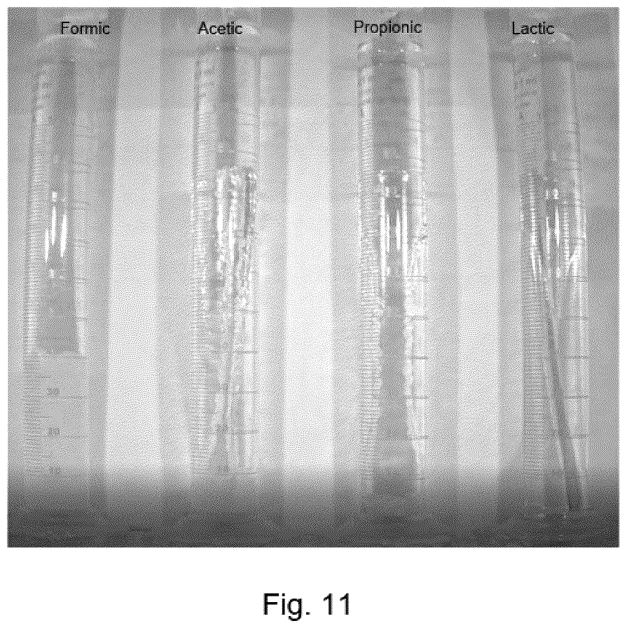

FIG. 11 is an image taken mid-experiment of screening of fractionating rates for formic acid, acetic acid, propionic acid, and lactic acid.

### Example 5: Measurement of Fractionation Rate with Different Concentrations of Formic Acid

Fractionation rates were measured using standard epoxy clear cast dogbones as prepared in example 1. Each dogbone was set in a 100 mL measuring cylinder with volume marking on the glassware for each mL. At time=0 minutes, a swelling fluid was poured over the dogbones. A timelapse video camera was set to record the fractionation progress. During fractionation, grains of thermoset epoxy resin was dislocated from the samples and deposits as a slurry in the bottom of the measuring glass. Fractionation progression (measured in %) at respective elapsed periods of time of the experiment from pouring the liquid solvent over the dogbones, was defined as a powder volume reached at an elapsed period of time divided with an end volume reached of the respective sample, which end volume was determined as a plateau after sufficient elapsed time i.e. the fractionation progress has reached a maximum. Solutions investigated includes swelling fluids comprising formic acid in water with respectively 20 v/v % (5 mol/L), 40 v/v % (10 mol/L), 60 v/v % (16 mol/L), 80 v/v % (21 mol/L), 100 v/v % (26 mol/L) volume percentage of formic acid in water.

From this experiment it was possible to extract an approximate rate of degradation for such specimen in these solutions, revealing that swelling fluid comprising formic acid leads to a swelling induced fractionation even when diluted with water to a 20% volume with water, and likely even in lower concentrations when extrapolating from data points. Also, the experiment reveals that the more concentrated the formic acid solution, the faster the fractionation occurs.

FIG. 12 is a graph comparing the degree of fractionation reached for clear cast epoxy dogbones after an elapsed time of experiment measured in hours, in swelling fluid containing respectively 20 v/v % (5 mol/L), 40 v/v % (10 mol/L), 60 v/v % (16 mol/L), 80 v/v % (21 mol/L), 100 v/v % (26 mol/L) formic acid in water. These results reveal a slower fractionation rate the more diluted the formic acid.

### Example 6: Measurement of Swelling Rates of Glass Fiber Pultrusion Samples

Swelling rates were measured using 5 different samples of unidirectional pultrudates comprising glass fiber embedded in 5 different formulations of cured thermoset epoxy resins. Samples were cut into samples of 20 cm×1 cm×0.2 cm, with the fiber direction along the longest (20 cm) direction. All 5 samples were submerged in swelling fluid comprising formic acid (78 v/v % in water) for extended period of time. Each hour a camera photographed the samples from a fixed distance. The swelling was observed to happen perpendicular to the fiber direction. Swelling was reported along this axis as a percentage of elongation compared to its original size of 1 cm, on each camera photo.

FIG. 13 is a graph showing the swelling of the 5 different epoxy pultrudates consisting of 5 different formulations of cured thermoset epoxy resins and glass fiber, over an elapsed time of 900 minutes. The graph reveals that all 5 samples elongates by more than 25% along the axis perpendicular to the fiber direction due to swelling upon exposure to the solution for at least 200 minutes and at most 850 minutes, for each type of cured thermoset epoxy resins.

FIG. 14 is a picture of a pultrusion samples after exposure to swelling fluid comprising 78 v/v % formic acid in water solution for 900 minutes. Free glass fiber strings are now exposed, and tiny thermoset epoxy fractions of liberated thermoset epoxy matrix are observed on the underlying plastic sheet.

### Example 7: Disassembly of Epoxy-Glass Fiber Laminates

A glass fiber reinforced composite laminate consisting of 12 layers of commercial glass fiber mats and a thermoset epoxy matrix obtained from commercial epoxy and hardener resin vacuum infused into the glass fiber layers, was cut in a smaller square, of approximately 10 cm×10 cm. In one corner a hole (12) was drilled, and below the hole, as illustrated by the drawing in FIG. 15. A cut 11 was made from the outside into the midst layer. The sample 10 was hung by a cord 13 through the drilled hole 12 and set in a 1 L beaker, filled with a swelling fluid consisting of formic acid 78 v/v % in water. The entire process was filmed by a camera, for 12 hours. After approximately 2 hours the outermost layers of fiber/epoxy composite was liberated from the sample and falls to the bottom of the beaker. Consistently over the next 10 hours layer for layer the outermost layers disconnects from the structure and deposits at the bottom, leaving only the two innermost layers hanging in the cord. During the process, a slurry of white epoxy fractions was observed, and also larger pieces of fractionated epoxy was noticed on the layers of glass fiber and in the bottom of the beaker.

FIG. 15 shows a simple representation of the experiment, where the cord 13 was taken through a drilled hole 12 in the sample 10 of laminate structure. Below the hole 12, a cut 11 has been made from each side going from the outside into the innermost layer, ensuring the sample 10 can hang from the cord 13 as long as the surrounding thermoset epoxy matrix glues the layers together, but losses the layers upon fractionation of the thermoset epoxy matrix.

FIGS. 16(a)-16(d) show the disassembly of an epoxy glass laminate hanging from the cord 13 at the top of a 1000 mL beaker filled with 78 v/v % formic acid in water, after 27 minutes (a), 101 minute (b), 6 hours and 56 minutes (c), and 8 hours and 54 minutes (d). Continuous separation of glass laminates and liberation of thermoset epoxy fractions was observed.

### Example 8: Disassembly of Complex Sample from a Decommissioned Wind Turbine Blade

A sample cut to a rectangular shape of 25 cm×25 cm from a decommissioned wind turbine blade, known beforehand to comprise at least some layers of thermoset epoxy matrix and glass fiber composite, as well as a cured epoxy-based glue, in addition to structural units was prepared. It was submerged into a swelling fluid comprising formic acid solution of 78 v/v % in water and left under a lid for 40 hours at room temperature. Afterwards, the entire structure was separated manually, by hand, into its components, comprising:
Glass fiber layers
A lightning protection grid
A pile of fractionated epoxy
Paint
A carbon reinforced composite
Core-elements

Each solid element on the above list was left to dry in a fume hood for at least 24 hours, or until the odor from formic acid was gone.

The remaining swelling fluid consisting of a slurry of fractionated epoxy fragments in the swelling fluid, was filtered to obtain clear swelling fluid and even more thermoset epoxy fractions. The filtered swelling fluid was subsequently used for a similar experiment using another composite structure cut out sample similar to the above. The reused swelling fluid behaved similar to the new, highlighting the possibility for reusing the swelling fluid.

### Example 9: Disassembly with Other Organic Acids

A composite structure sample from a decommissioned wind turbine blade consisting of structural units and fibers set in an epoxy thermoset matrix is cut into a rectangular square of approximately 25 cm×25 cm. It is submerged into a swelling fluid comprising two parts formic acid and one part of least one additional organic acid, such as acetic acid, trifluoroacetic acid, trichloroacetic acid, propionic acid, methanesulfonic acid, trifluoromethanesulfonic acid, performic acid or anhydride of any of these. The composite structure is left under a lid for 40 hours. Afterwards, the swelling fluid is drained through an outlet into a waste container. The solid elements are washed three times with water, and dried in a ventilated atmosphere. When dry, each solid element is separated gathered manually by hand and the released thermoset epoxy fractions are collected.

### Example 10: Disassembly with Alcohols

A composite structure sample from a decommissioned wind turbine blade consisting of structural units and fibers set in an epoxy thermoset matrix is cut into a rectangular square of approximately 25 cm×25 cm. It is submerged into a swelling fluid comprising two parts formic acid and one part of at least one alcohol, such as methanol, ethanol, propanol, isopropanol, butanol, t-butanol, or amyl alcohol. The composite structure is left under a lid for 40 hours. Afterwards, the swelling fluid is drained through an outlet into a waste container. The solid elements are washed three times with water, and dried in a ventilated atmosphere. When dry, each solid element is separated gathered manually by hand.

### Example 11: Disassembly with Solvents

A composite structure sample from a decommissioned wind turbine blade consisting of structural units and fibers set in an epoxy thermoset matrix is cut into a rectangular square of approximately 25 cm×25 cm. It is submerged into a swelling fluid comprising two parts formic acid and one part of an additional solvent, such as tetrahydrofuran (THF), dimethylformamide (DMF), N-Methyl-2-pyrrolidone (NMP), dimethyl sulfoxide (DMSO), dichloromethane, chloroform, acetone, acetonitrile, chlorobenzene, diethylether, dioxane, ethylene glycol, polyethylene glycol (PEG), glycerin, hexamethylphosphoramide (HMPA), nitromethane, pyridine, trimethylamine, toluene, xylene, benzene, dimethylacetamide (DMAc), dimethoxyethane (DME), diglyme, dichloroethan. The composite structure is left under a lid for 40 hours. Afterwards, the swelling fluid is drained through an outlet into a waste container. The solid elements are washed three times with water, and dried in a ventilated atmosphere. When dry, each solid element is separated gathered manually by hand and the released thermoset epoxy fractions are collected.

### Example 12: Disassembly with Salts

A composite structure sample from a decommissioned wind turbine blade consisting of structural units and fibers set in an epoxy thermoset matrix is cut into a rectangular square of approximately 25 cm×25 cm. It is submerged into a swelling fluid comprising two parts formic acid and a saturated aqueous solution of at least one dissolved salt, such as NaCl, KCl, CsCl, NaHCO3, KHCO3, CsHCO3, Na2CO3, K2CO3, and Cs2CO3. The composite structure is left under a lid for 40 hours. Afterwards, the swelling fluid is drained through an outlet into a waste container. The solid elements are washed three times with water, and dried in a ventilated atmosphere. When dry, each solid element is separated gathered manually by hand and the released thermoset epoxy fractions are collected.

### Example 13: Disassembly with Surfactants

A composite structure sample from a decommissioned wind turbine blade consisting of structural units and fibers set in an epoxy thermoset matrix is cut into a rectangular square of approximately 25 cm×25 cm. It is submerged into a swelling fluid comprising two parts formic acid and an aqueous solution containing a surfactant. The composite structure is left under a lid for 40 hours. Afterwards, the swelling fluid is drained through an outlet into a waste container. The solid elements are washed three times with water, and dried in a ventilated atmosphere. When dry, each solid element is separated gathered manually by hand and the released thermoset epoxy fractions are collected.

### Example 14: Disassembly of a Wind Turbine Blade

A 1000 Liter (L) IBC tank is modified with a removable, non-permeable, lid, and two tubes connected to an external heater with a circulating pump. A wind turbine blade is cut into appropriate composite structure pieces fitting into a 1000 L IBC tank. The composite structure pieces are stacked as high as possible, without interfering with the lid. A swelling fluid comprising formic acid is added on top of the composite structure pieces, and the swelling fluid sealed with the lid. Heat is started and the swelling fluid is left for an appropriate time for complete disassembly composite structure pieces. After ended experiment, the swelling fluid is pumped through a filter and into a separate 1000 L. The lid is removed and the empty tank is allowed to steam off the remaining swelling fluid. From the filter thermoset epoxy fractions are collected and stored. When dry, and the smell of formic acid has disappeared, each solid elements including fiber material is moved to a separate tank where it is flushed with a high pressure water (flushing fluid) jet, to remove any adhering thermoset epoxy fractions. The water slurry of thermoset epoxy fractions from the flushing is filtered, and the thermoset epoxy fractions from the filter is stored together with the other collected thermoset epoxy fractions and left to dry. The washed solid elements are dried and separated into appropriate recycling bins.

### Example 15: Disassembly of an Entire Wind Turbine Blade

A composite structure in the form of a full wind turbine blade is dismantled from a wind turbine nacelle and transported to a facility. At the facility it is bound in chains attached to a crane. Slowly the wind turbine blade is lowered into a pool containing formic acid containing swelling fluid. The pool is sealed with an appropriate non-permeable sheet, and the entire pool is heated, and stirred, using recirculating jets. After appropriate time for disassembling, the sheet covering the pool is removed. The pool is emptied and the swelling fluid is transported to a separate container and filtered to collect thermoset epoxy fractions. The solid elements remain in the otherwise empty pool. The pool is allowed time to evaporate most of the formic acid off, into a condenser, responsible for reobtaining most of the formic acid for circularity. When sufficiently dry, the chains are again connected to a crane, to gently remove the largest pieces of solid elements such as large fabrics of glass fiber, core-elements such as foam, lightning protection, wires, etc. Thermoset epoxy fractions are recovered from the bottom of the pool area. Sheets of fiber, and other solid elements to which thermoset epoxy fractions adhere are subjugated to a flushing using high pressure jet of flushing water. The slurry of water and thermoset epoxy fractions from said flushing is filtered, to isolate even more thermoset epoxy fractions. The remaining solid elements including fibers are dried. Then all solid elements are divided into appropriate recycling bins according to its material.

### Example 16: Disassembly of Wind Turbine Blade Sections by Rinsing

A closed container is fitted in its ceiling and side walls with shower heads. The bottom of the container is fitted with drains, having a fine sieve, for filtration. Filtered swelling fluid is recirculated into the tank from which the shower heads draw its swelling fluid, in this case a swelling fluid comprising formic acid. In the ceiling of the container a fan is located, connected to a tube fitted with a condensing unit. The fan ensures that formic acid vapors from the container is sucked into the condenser, where it condensates and drops into the tank from which the shower heads draw its liquid.

An appropriate composite structure piece cut from a wind turbine blade is fitted into the container. After the doors are closed, the showers and the fan are externally turned on. After appropriate time rinsing the wind turbine blade composite structure piece with the swelling fluid, the shower heads are turned off, and a fan is set to high speed, to dry out the remaining formic acid stuck in the piece.

When safe, the door is opened, and each solid element is separated out. Each solid element including fiber material is moved to a separate tank where they are flushed with a high pressure water jet, to remove any adhering thermoset epoxy fractions. The water slurry of thermoset epoxy fractions from said flush is filtered, and the thermoset epoxy fractions from the filter is collected and stored together with the thermoset epoxy fractions trapped by the sieve located in the bottom of the container. The washed solid elements are dried and separated into appropriate recycling bins.

### Example 17: Measurement of Fractionation Rate with Different Epoxy Clearcast

Fractionation rates of 11 samples I-XI of cured dogbones made from epoxy resins and hardeners as listed in table 1. The respective epoxy resins and hardeners are available from Olin Corporation (olinepoxy.com). The respective dogbone samples were prepared using the same method as described in example 1.

All samples were mixed in the ratios recommended by the supplier.

Each dogbone was set in a 100 mL measuring cylinder and analysed according to the experimental procedure described in example 3 using a swelling fluid in the form of an aqueous formic acid solution (78 v/v %). The results obtained from the analyses of the respective 11 dogbone samples reveal that the swelling fluid applied fractionates a variety of different epoxy formulations.

Rate of fractionation is categorized in four categories. Each category is defined by comparing rate of fractionation with a standard epoxy clear cast dogbone, as described in Example 3. Category 1) fractionated with a faster fractionation rate than the fractionating rate of the reference of example 3. Category 2) fractionated with a fractionation rate corresponding to the fractionating rate of the reference of example 3. Category 3) fractionated with a lower fractionation rate than the fractionating rate of the reference of example 3. Category 4) fractionated with a fractionation rate much slower (>50% slower) than the fractionating rate of the reference of example 3.

TABLE 1

| | | | Rate compared |
|---|---|---|---|
| # | Epoxy | Hardener | to the reference |
| I | Airstone ™ type 1 - | Airstone ™ type | Same (2) |
| | Liquid epoxy resin, | 1 - Amine | |
| | Bisphenol A based | based | |
| II | Airstone ™ type 2 - | Airstone ™ type | Slower (3) |
| | Liquid epoxy resin, | 2 - Amine | |
| | Bisphenol A based | based | |
| III | Airstone ™ type 3 - | Airstone ™ type | Faster (1) |
| | Liquid epoxy resin, | 3 - Amine | |
| | Bisphenol A based | based | |
| IV | Airstone ™ type 4 - | Airstone ™ type | Same (2) |
| | Liquid epoxy resin, | 4 - Amine | |
| | Bisphenol A based | based | |
| V | Liquid epoxy resin - | Airstone ™ type | Faster (1) |
| | Bisphenol F based | 1 - Amine | |
| | | based | |
| VI | Liquid epoxy resin - | Airstone ™ type | Same (2) |
| | Novolac based | 1 - Amine | |
| | | based | |
| VII | Liquid epoxy resin - | Amine based | Faster (1) |
| | Bisphenol A based | hardener | |
| VIII | Liquid epoxy resin - | Amine hardener | Much slower (4) |
| | Bisphenol A based | based on TETA | |
| IX | Liquid epoxy resin - | Amine hardener | Slower (3) |
| | Bisphenol A based | based on IPDA | |
| X | Liquid epoxy resin - | Litestone ® | Much slower (4) |
| | Bisphenol A based | amine based | |
| | | hardener | |
| XI | Liquid epoxy resin - | Amine hardener | Slower (3) |
| | Bisphenol A based | based on MXDA | |

TETA = Triethylenetetraamine
IPDA = Isophorone diamine
MXDA = meta-xylenediamine

As described above, the fractionation rate for respective thermoset epoxy compositions may be optimized, e.g. by adjusting the composition of the swelling fluid or performing the soaking at increased temperature and/or pressure.

### Example 18: Measurement of Fractionation Rate at Different Temperatures

Fractionation rates were measured using clear cast dogbones as prepared in example 1. Four dogbones were each set in a 100 mL measuring cylinder immersed in a 500 mL beaker with demineralized water and a magnetic stirbar placed on top of a magnetic stirrer with temperature control. Each beaker was set to a temperature of either 20, 40, 60, or 80° C. At time=0 minutes, a swelling fluid in the form of an aqueous formic acid solution (78 v/v %) was poured over each of the dogbones. The swelling fluid had a temperature of 25° C. at the time of pouring. A timelapse video camera was set to record the fractionation progress. The fractionation was analysed according to the experimental procedure from example 3. From this experiment it was possible to extract rate of degradation rate at different temperatures. It was found that the rate increases with approximately a factor of 2 for each 20° C. temperature increase. It can therefore be concluded that increasing the temperature may result in an even faster fractionation rate.

### Example 19 Measurement of Fractionation Rate in Fluid Containing Salts

### Preparation of Salt Solutions

Several days in advance, stock solutions of saturated aqueous solutions of salts were prepared. The stock solutions were prepared by dissolving 40 g salt (see the list) in 100 mL demineralized water in a beaker. If the salt was dissolved fully, another 20 g salt was added. This was continued, with the addition of 20 g salt, until the residual salt was observed as an undissolved precipitate. The solutions were left for five days, and all the solutions had a clear precipitate of undissolved salts located in the bottom of the beaker.

Fifteen stock solutions were prepared using one of the following salts: ZnCl₂, NaOAc, NaI, KCl, NaSO₄, NaCl, KOAc, CuCl₂, NaBr, CaCl₂, LiBr, AlCl₃, NaNO₃, KNO₃, NH₄NO₃.

Fractionation rates were measured using clear cast dogbones as prepared in example 1. Each dogbone was set in a 100 mL measuring cylinder with volume marking on the glassware for each mL. At time=0 minutes, a swelling fluid comprised of formic acid (99 v/v % 75 mL) and a saturated aqueous stock solution of a salt (25 mL) was poured over the dogbones. A timelapse video camera was set to record the fractionation progress. The fractionation rates of and degradation effect of the respective swelling fluids were analyzed according to the experimental procedure from example 3.

From this experiment it was possible extract an approximate fractionation rate of the respective dogbones degraded by the respective different swelling fluids with the different dissolved salts and thereby the effect of the fractionation rate of the dogbone using swelling fluids comprising the dissolved salts of the respective 15 stock solutions could be estimated.

All the recorded fractionation rates were significantly slower compared to a reference experiment using the same procedure with formic acid (99 v/v %, 75 mL) and demineralized water (25 mL) as fluid medium.

For the experiments applying the salt solutions of NaSO₄ and KNO₃, the fractionation rates were slightly more than 50% compared to the fractionation rate of the reference experiment. For the remaining experiments applying salt solutions the fractionation rates were more than 50% slower than the fractionation rate of the reference experiment.

### Example 20 Loss of Mechanical Strength of Epoxy-Glass Fiber Laminates

A glass fiber reinforced composite laminate consisting of 4 layers of commercial glass fiber mats and a thermoset epoxy matrix obtained from commercial epoxy and hardener resin vacuum infused into the glass fiber layers, was cut in a smaller rectangular plank of approximately 2 cm×15 cm. The plank was submerged into a crystallization beaker of 2 liters, and held horizontally in the middle of the bowl by a clamp. At time=0, a swelling fluid in the form of an aqueous formic acid solution (78 v/v %) was poured over the plank to fully embed the plank. A timelapse video camera was set to record the changes over time.

FIG. 17a shows the plank at the time=0. It can be seen that the plank is fully intact and horizontally orientated.

FIG. 17b shows the plank at the time=3 hours. It can be seen that the plank remains horizontally orientated, however, minor sign of degradation is visible at the lower surface of the plank.

FIG. 17c shows the plank at the time=6 hours. The plank is no longer horizontally orientated and is shows significant signs of degradation comprising separation of the layers of glass fiber mats.

From this experiment it was possible to visualize the loss of mechanical strength of epoxy-glass fiber laminates over time. This is observed when the plank starts to delaminate into separate pieces of glass-fiber mat, and bends towards the bottom of the beaker because of gravitational pull.

1. A method of extracting of thermoset epoxy fractions from a composite structure comprising thermoset epoxy matrix and embedded solid element(s), wherein the thermoset epoxy matrix has a network structure, the method comprising
providing a swelling fluid
soaking the composite structure with the swelling fluid and allowing the thermoset epoxy matrix to swell the swelling fluid into the network structure of the thermoset epoxy matrix for a sufficient time to mechanically break up the network structure to form a multitude of thermoset epoxy fractions liberated from the solid element(s) and
separating at least a portion of said thermoset epoxy fractions from the solid element(s) to obtain a swelling fluid slurry comprising said portion of said thermoset epoxy fractions in said swelling fluid,
wherein the swelling fluid comprises at least 1 mol/L of formic acid, such as at least 3 mol/L, such as at least 5 mol/L, such as at least 10 mol/L, such as at least 18 mol/L, such as at least 20 mol/L, such as at least 22 mol/L, such as at least 24 mol/L, such as at least 26 mol/L of formic acid.

2. The method of claim 1, wherein the step of providing the swelling fluid comprises providing the swelling fluid to comprise additional components, optionally the step of providing the swelling fluid comprises mixing formic acid with one or more further components and optional reaction components formed.

3. The method of claim 1 or claim 2, wherein the swelling fluid is an aqueous solution comprising said formic acid.

4. The method of claim 2 or claim 3, wherein the additional component comprises at least one additional organic acid, such as acetic acid, trifluoroacetic acid, trichloroacetic acid, propionic acid, methanesulfonic acid, trifluoromethanesulfonic acid, performic acid or anhydride of any of these and/or at least one inorganic acid, such as hydrochloric acid.

5. The method of any one of the preceding claims 2-4, wherein the additional component comprises at least one alcohol, such as methanol, ethanol, propanol, isopropanol, butanol, t-butanol, amyl alcohol.

6. The method of any one of the preceding claims 2-5, wherein the additional component comprises an additional solvent, such as tetrahydrofuran (THF), dimethylformamide (DMF), N-Methyl-2-pyrrolidone (NMP), dimethyl sulfoxide (DMSO), dichloromethane, chloroform, acetone, acetonitrile, chlorobenzene, diethylether, dioxane, ethylene glycol, polyethylene glycol (PEG), glycerin, hexamethylphosphoramide (HMPA), nitromethane, pyridine, trimethylamine, toluene, xylene, benzen, dimethylacetamide (DMAc), dimethoxyethane (DME), diglyme and/or dichloroethan.

7. The method of any one of the preceding claims 2-6, wherein the additional component comprises at least one dissolved salt, such as NaCl, KCl, CsCl, NaHCO₃, KHCO₃, CsHCO₃, Na₂CO₃, K₂CO₃, Cs₂CO₃, any salt comprising a quaternary ammonium cation, and any salt comprising either a tetrafluoroborate anion or hexafluorophosphate anion.

8. The method of any one of the preceding claims 2-7, wherein the additional component comprises at least one surfactant, preferably selected from anionic and/or non-ionic surfactant, such as sulfates, sulfonates, gluconate, cocamide, ethoxylates, and/or alkoxylates.

9. The method of any one of the preceding claims 2-8, wherein the type and amount of the at least one additional component is selected in dependence of the embedded solid elements, preferably to provide that the soaking of the composite structure in the swelling fluid does not provide any substantial solvation or disintegration of the embedded solid elements.

10. The method of any one of the preceding claims, wherein the swelling fluid has a pH value of 2 or larger, such as between 2.5 and 4.

11. The method of any one of the preceding claims, wherein the thermoset epoxy matrix of said composite structure comprises an epoxy based on at least one reactant comprising at least one epoxy resin, wherein epoxy resin has been cured by irradiation (e.g. ionization, IR-radiation, e-beam etc.) and/or or by being subjected to at least one hardener, such as one or more anhydride curing agent, one or more thiol curing agent and/or one or more amine curing agent.

12. The method of any one of the preceding claims, wherein the thermoset epoxy matrix of said composite structure comprises an epoxy based on at least one epoxy resin, wherein epoxy resin has been cured by at at least one hardener, comprising an amine based hardener, such as an aliphatic amine based hardener, an aromatic amine based hardener and/or a multifunctional amine hardener.

13. The method of any one of the preceding claims, wherein the thermoset epoxy matrix does not include a disulfide bridge moiety.

14. The method of claim 2, wherein reactants do not include a disulfide bridge moiety.

15. The method of any one of the preceding claims, wherein the embedded solid element(s) comprises at least one of reinforcement element(s), and support elements, wherein the support elements includes any elements that are not having reinforcing function, such as filler, shaping aid, electrical component, lightning protections, paint, glue and/or core elements such as foams and/or woods.

16. The method of any one of the preceding claims, wherein the embedded solid element(s) comprises at least one reinforcement layer, such as two or more reinforcement layers glued together by the thermoset epoxy matrix, such as layers comprising one or more of fibers, metal, polymer, wood, ceramic, silicates and/or paint.

17. The method of any one of the preceding claims, wherein the embedded solid element(s) comprises fibers selected from one or more of synthetic fiber, semi-synthetic fiber, regenerated fiber, plant fiber, carbon fiber, basalt fiber, glass fiber and/or metal fiber, the fiber may preferably be in the form of at least one sheet comprising fibers e.g. at least one sheet comprising fibers embedded in a polymer different from the thermoset epoxy matrix.

18. The method of any one of the preceding claims, wherein the embedded solid element(s) comprises wood, such as balsa and/or foamed plastic such as foamed plastic comprising at least one of polystyrene (PS), polyurethane (PU), poly(vinyl chloride) (PVC), polyethylene terephthalate (PET), polyolefins (polyethylene (PE) and polypropylene (PP)) and ABS foams, preferably the foamed plastic is rigid.

19. The method of any one of the preceding claims, wherein the solid element(s) comprises reinforcement elements comprising at least one metal, such as steel, aluminum, titanium, chromium, cobalt, nickel, copper, zinc, tin, lead and any alloys comprising at least one of the before mentioned, preferably the metal comprises a grid, a wire and/or a girder.

20. The method of any one of the preceding claims, wherein the embedded solid element(s) comprises at least one additional thermoset matrix comprising comprises cross-linked polyester, polyurethane, vulcanized rubber, cross-linked polyvinylester, cross-linked polyimides, cross-linked phenol-formaldehyde, cross-linked polybenzoxazine, cured amino resin, cured furan resin, cured maleimide resin, or cured silicone or any combinations comprising at least one of the before mentioned.

21. The method of any one of the preceding claims, wherein the step of soaking the composite structure with the swelling fluid is performed at a temperature of the swelling fluid up to 100° C., such as from 8° C. to 75° C., such as from 10° C. to 50° C., such as from 20° C. to 35° C., such as 22° C. to 27° C. of the swelling fluid.

22. The method of any one of the preceding claims, wherein the step of soaking the composite structure with the swelling fluid is performed at atmosphere pressure or at elevated pressure, such as up to a pressure of 3 bar, such as up to a pressure of 2 bar, such as up to a pressure of 1.5 bar.

23. The method of any one of the preceding claims, wherein the step of soaking the composite structure with the swelling fluid comprises contacting the composite structure with the swelling fluid in a treatment container, wherein the container preferably is a closed or a closable container.

24. The method of any one of the preceding claims, wherein the step of soaking the composite structure with the swelling fluid comprises arranging the composite structure in a volume of the swelling fluid in a treatment container and/or sprinkling the composite structure with the swelling fluid in a treatment container.

25. The method of any one of the preceding claims, wherein the step of soaking the composite structure with the swelling fluid comprises transporting the composite structure through a treatment location stepwise or continuously where the composite structure is treated with the swelling fluid, preferably the step of soaking the composite structure with the swelling fluid comprises arranging the composite structure on a conveyor belt and transporting the composite structure through a treatment container where it is treated with the swelling fluid e.g. by sprinkling.

26. The method of any one of the preceding claims, wherein the step of soaking the composite structure with the swelling fluid comprises contacting the composite structure with the swelling fluid for a period up to 144 hours, such as from 1 to 130 hours, such as from 10 hour to 100 hours, such as from 24 to 96 hours, for example up to 72 hours, such as up to 48 hours.

27. The method of any one of the preceding claims, wherein the step of soaking the composite structure with the swelling fluid comprises subjecting the composite structure and/or the swelling fluid to vibrations e.g. using ultrasound and/or subjecting swelling fluid to motions e.g. using stirring, shaking and/or blowing gas through the swelling fluid.

28. The method of any one of the preceding claims, wherein the step of separating the thermoset epoxy fractions from the solid elements, comprises separating the solid elements and the swelling fluid by withdrawing the swelling fluid from the solid elements to obtain said swelling fluid slurry or by removing the solid elements from the swelling fluid to obtain said swelling fluid slurry.

29. The method of any one of the preceding claims, wherein the step of separating the thermoset epoxy fractions from the solid elements, comprises subjecting the solid elements to at least one washing process, preferably comprising washing the solid elements using a washing fluid to obtain a washing fluid slurry of at least a portion of said thermoset resin fractions in said washing fluid, wherein the washing fluid preferably comprises a surfactant, wherein the surfactant preferably comprises an anionic surfactant and/or an amphiphilic surfactant, such as a quaternary ammonium surfactant.

30. The method of any one of the preceding claims, wherein the step of separating the thermoset epoxy fractions from the solid elements comprises subjecting the solid elements to at least one flushing process, such a high pressure flushing, using a flushing fluid selected from a flushing gas, a flushing liquid or a mixture thereof, to thereby obtain a flushing fluid slurry of at least a portion of said thermoset resin fractions in said flushing fluid.

31. The method of any one of the preceding claims, wherein the step of separating the thermoset epoxy fractions from the solid elements comprises mechanically deforming the solid elements, such as crushing the solid elements and/or throbbing the solid elements.

32. The method of any one of the preceding claims, wherein the step of separating the thermoset epoxy fractions from the solid elements, comprises mechanically removing thermoset epoxy fractions from the solid elements, e.g. by scraping and/or combing.

33. The method of any one of the preceding claims, wherein the step of separating the thermoset epoxy fractions from the solid elements, comprises subjecting the solid elements to vibrations and/or shaking, such as applying an ultrasonic field to the solid elements and/or moving the solid elements to and fro.

34. The method of any one of the preceding claims, wherein the step of separating the thermoset epoxy fractions from the solid elements, comprises filtering.

35. The method of any one of the preceding claims, wherein the method further comprises filtering said swelling fluid slurry to collect at least a portion of said thermoset epoxy fractions from said swelling fluid slurry, wherein the method preferably further comprises recirculating the swelling fluid e.g. for use in the method according to any one of the preceding claims.

36. The method of any one of the preceding claims 29-35, wherein the method further comprises filtering said washing fluid slurry and/or said flushing fluid slurry to collect at least a portion of said thermoset epoxy fractions from said washing fluid slurry and/or said flushing fluid slurry.

37. The method of claim 35 or claim 36, wherein the method comprises subjecting said collecting portion(s) of thermoset epoxy fractions to a further washing step and/or drying said portion(s) of thermoset epoxy fractions.

38. The method of any one of the preceding claims, wherein the method further comprises subjecting the thermoset epoxy fractions to a step of depolymerisation, e.g. using good solvent of NMP (N-Methyl-2-pyrrolidone)), the organic catalyst Triazabicyclodecene (TBD), and the alcohol ethylene glycol (EG).

39. The method of any one of the preceding claims, wherein the composite structure has a maximal dimension of at least 0.1 m, such as at least 1 m, such as at least 5 m, such as at least 10 m, such as from 15 to 200 m, such as from 20-100 m.

40. The method of any one of the preceding claims, wherein the composite structure is an entire or a portion of a wind turbine blade, an airplane, a ship, an automobile, a bridge decking, a boat, an aircraft and/or a circuit board.
